(19) United States
(12) Patent Application Publication
(10) Pub. No.: US 2004/0244858 A1
(43) Pub. Date: Dec. 9, 2004

(54) Spiral hose using polyethylene

(76) Inventor: In-Seon Jeong, Seoul (KR)

Correspondence Address: Mitchell P Brook, Luce Forward Hamilton & Scripps, Suite 200, 11988 El Camino Real, San Diego, CA, 92130, US

(21) Appl. No.: 10/484,553

(22) PCT Filed: Jul. 24, 2002
(86) PCT No.: PCT/KR02/01387

(30) Foreign Application Priority Data
Jul. 24, 2001 (KR) 2001-22364 U
Jan. 15, 2002 (KR) 2002-2357
Jan. 15, 2002 (KR) 2002-2358
Jan. 15, 2002 (KR) 2002-2359
Feb. 7, 2002 (KR) 2002-7141
Mar. 13, 2002 (KR) 2002-13572

(51) Int. Cl. F16L 11/00

(52) U.S. Cl. 138/122; 138/125; 138/129; 138/149; 138/134

(57) ABSTRACT

Disclosed is a spiral hose which includes a hard spiral member made from polyethylene and a thin soft spiral member made from polyethylene tarpaulin, and which can be used not only as a general hose but also as a gas duct or a watering hose. The spiral hose is wound in a spiral shape to have flexibility. The spiral hose comprises: a hard member made from polyethylene, which is wound in a spiral shape with a uniform spiral gap formed between turns of the hard member, and a soft member having a shape of a band and being formed of polyethylene tarpaulin, the soft member being disposed along the spiral gap while lateral edges of the soft member are fixed to portions of the hard member, which are disposed oppositely on both sides of the spiral gap.

### TECHNICAL FIELD

The present invention relates to a spiral hose, and more particularly to a spiral hose, and more particularly to a spiral hose which includes a hard spiral member made from polyethylene and a thin soft spiral member made from polyethylene tarpaulin, and which can be used not only as a general hose but also as a gas duct or a watering hose.

### BACKGROUND ART

In general, spiral hoses are used in pumping up and transferring liquid such as water. It is required that water should be prevented from leaking through the entire wall of the spiral hose, that inner surfaces of the spiral hose be prevented from adhering to each other by the pressure of the water passing through the spiral hose, and that the spiral hose have flexibility, in contrast with a usual pipe.

A spiral hose currently used includes a hard spiral member protruding outward and bearing the pressure of the water in the hose and a soft spiral member providing flexibility, which together forms a shape of the spiral hose.

The soft spiral member is fabricated by adding a plasticizer to a polyvinyl chloride (PVC) having a specific gravity of about 1.2 to 1.5 so that the soft spiral member can have flexibility. Therefore, the soft spiral member should have a considerable thickness in order to have a tensile strength capable of enduring the water pressure concentrated on the soft spiral member instead of the hard spiral member connected with both sides of the soft spiral member. As a result, the conventional spiral hose not only requires a high manufacturing cost but also has a large weight which requires much manpower and time in carrying or installing the conventional spiral hose.

Meanwhile, there has been often utilized a hose made from polyethylene having a specific gravity of about 0.9 with a uniform thickness. In this case, when the hose is made from polyethylene having a relatively large thickness in order to increase its resistance to internal pressure, the hose is too hard to have flexibility. Therefore, the polyethylene hose cannot be employed as a spiral hose for middle or high pressure but has been employed as a very thin spiral hose for ultra-low pressure.

### DISCLOSURE OF THE INVENTION

The present invention has been made in view of the above-mentioned problems, in consideration of the fact that polyethylene tarpaulin has a higher tensile strength while being much thinner than PVC.

Therefore, it is an object of the present invention to provide a spiral hose utilizing polyethylene, in which a hard member made from polyethylene has a sectional shape protruding outward with angular corners and extends in a spiral shape, and a soft member made from polyethylene tarpaulin with a small thickness is attached to the hard member while extending along a spiral gap formed between each turns of the spiral hard member, so that the spiral hose has not only a sufficient resistance to internal pressure owing to the hard polyethylene member but also a high tensile strength and excellent flexibility owing to the soft member made from polyethylene tarpaulin, and so that, in comparison with a PVC hose, the spiral hose having the same resistance to pressure can be manufactured at a lower cost and has smaller weight which enables the spiral hose to be easily carried and installed.

It is another object of the present invention to provide a spiral hose utilizing polyethylene, in which a coated polyethylene tarpaulin layer forming a soft member has a plurality of spray holes, so that the spiral hose may be utilized as a watering hose.

It is another object of the present invention to provide a spiral hose utilizing polyethylene, in which each interval between wefts and between warps of a woven polyethylene fabric layer has a wide distance of 5 to 20 mm, so that the spiral hose can be employed as a gas duct which can be bent more than 90° when the duct is installed.

It is another object of the present invention to provide a spiral hose utilizing polyethylene, which includes a hard member and a soft member attached to each other, and a fastening band attached along a joint portion between the hard and soft members, so that the hard and soft members can be water-tightly assembled together without a separate coating and with an increased cohesion between the hard and soft members.

It is another object of the present invention to provide a spiral hose utilizing polyethylene, in which a hard spiral member and a soft spiral member are assembled with each other while extending in a spiral shape, respectively, and a heat-insulation foam fixed in a spiral gap formed between turns of the hard spiral member, so that the spiral hose has an adiabatic characteristic without a separate heat-insulation cover.

It is another object of the present invention to provide a spiral hose utilizing polyethylene, which includes a hard spiral member and a soft spiral member assembled with each other while extending in a spiral shape, and a reinforcement member disposed along a spiral groove above the soft spiral member while connecting turns of the hard spiral member with each other, so as to reinforce the strength of the soft spiral member and uniformly maintain the spiral gap between the turns of the hard spiral member, thereby preventing the spiral hose from being expanded and contracted and highly improving the durability and marketability of the spiral hose.

It is another object of the present invention to provide a spiral hose utilizing polyethylene, which includes not only a hard spiral member and a soft spiral member attached to each other, but also a reinforcement piece disposed across the hollow space of the hard spiral member, which prevents the hard spiral member from being deformed by external force and prevents the strength and the draining function of the spiral hose from being deteriorated due to the possible deformation of the hard spiral member.

It is another object of the present invention to provide a watering hose utilizing polyethylene, in which a hard member made from polyethylene extends in a spiral shape with a spiral gap between turns of the hard member, and a soft member made from woven polyethylene fabrics is attached to the hard member while extending along the spiral gap, so that the watering hose has not only a sufficient resistance to internal pressure owing to the hard polyethylene member but also a high tensile strength and excellent flexibility owing to the soft member made from polyethylene tarpaulin, and can be manufactured at a lower cost and simplified process, thereby highly improving the productivity.

It is another object of the present invention to provide a watering hose utilizing polyethylene, which can be formed of a single polyethylene member wound in a spiral shape, so that the manufacturing process of the spiral hose can be simplified to thereby increase the productivity, and the joint portions of the single polyethylene member can have a stronger cohesion to thereby improve the durability of the spiral hose.

It is another object of the present invention to provide a watering hose utilizing polyethylene, which includes a polyethylene member having convex and concave portions and extending in a spiral shape, and a reinforcement band connected to adjacent concave portions to each other at each turn of the spirally wound polyethylene member to close the inner space of the convex portion, thereby increasing the strength of the spiral hose, preventing deformation of the spiral hose, and highly improving the durability of the spiral hose.

According to an aspect of the present invention, there is provided a spiral hose utilizing polyethylene wound in a spiral shape to have flexibility, the spiral hose comprising: a hard member made from polyethylene, which is wound in a spiral shape with a uniform spiral gap formed between turns of the hard member; and a soft member having a shape of a band and being formed of polyethylene tarpaulin, the soft member being disposed along the spiral gap while lateral edges of the soft member are fixed to portions of the hard member, which are disposed oppositely on both sides of the spiral gap.

The hard member may comprise a convex section protruding upward with angular corners and flanges extending laterally from lower ends of the convex section, and the lateral edges of the soft spiral member are attached to the flanges disposed oppositely on both sides of the spiral gap. In this case, the hard spiral member assembled with the soft member is bent and protrudes outward, and the flanges are integrally connected with each other, so as to form a space inside of the hard member.

The soft member may comprise a woven polyethylene fabric layer and at least one polyethylene coating layer coated on the woven polyethylene fabric layer, the polyethylene coating layer having a plurality of spray holes, so that the spiral hose can be used as a watering hose.

The soft member may be formed of polyethylene tarpaulin which includes a woven polyethylene fabric layer and at least one polyethylene coating layer coated on at least one surface of the woven polyethylene fabric layer, or may be formed of polyethylene tarpaulin, which includes a woven polyethylene fabric layer and low-density and high-density polyethylene coating layers coated in sequence on at least one surface of the woven polyethylene fabric layer.

Further, the soft member may be formed of polyethylene tarpaulin, both side edges of which are fixed to outer or inner surfaces of the flanges of the hard member, respectively. In this case, side ends of the polyethylene tarpaulin forming the soft spiral member are coated to form watertight ends.

The spiral hose may further comprise a fastening band attached along a joint portion between the hard member and the soft member.

Also, the spiral hose may further comprise a heat-insulation foam fixed in a spiral gap formed between turns of the hard member and on the soft member.

In this case, the hard member may be made from high-density polyethylene, the soft member is formed of polyethylene tarpaulin, and the heat-insulation foam is formed of polyethylene foam.

The spiral hose may further comprise an aluminum foil attached to an upper surface of the heat-insulation foam or an outer surface of the spiral hose. In the latter case, the hard member and the heat-insulation foam together form the outer surface of the spiral hose, and the aluminum foil is wound around the outer surface of the spiral hose in a spiral shape, thereby forming an outermost layer of the spiral hose.

The spiral hose may further comprise aluminum foils attached in sequence to one surface of the soft member or an aluminum foil having a shape of a band, which is attached to a lower surface of the heat-insulation foam. In this case, the reinforcement member may be made from soft material, may be fixed on the soft member, and may have transverse side ends fixed to both sides of the hard member, thereby maintaining a uniform between turns of the hard member.

In this case, the hard member and reinforcement member may be made from polyethylene, and the soft member may be made from at least one of polyethylene tarpaulin and soft polyethylene.

The reinforcement member may be a flexure cover which has side edges attached to adjacent side portions of an upper surface of the hard spiral member and a central portion being concave downward in a transverse sectional view of the flexure cover. The central portion of the flexure cover concave downward is fixed to an upper surface of the soft member disposed under the flexure cover.

The reinforcement member may be a flexure cover which has side edges and a central portion, the side edges being fixed between side edges of the soft member and side portions of a lower surface of the hard member, the central portion being concave upward in a transverse sectional view of the flexure cover.

The reinforcement member may be a flexure cover which has side edges and a central portion, the side edges being fixed onto an exposed surface of the soft member, the central portion being concave upward in a transverse sectional view of the flexure cover.

Also, the reinforcement member may be a flexure cover which has side edges and a central portion, the side edges being fixed to lower portions of side surfaces of the hard member, which are disposed both side of the soft member at each turn of the hard member, the central portion being concave upward in a transverse sectional view of the flexure cover.

The reinforcement member may be a hollow flexible member fixed in the spiral gap formed on the soft member, the hollow flexible member having outer side portions attached to adjacent outer side surfaces of the hard member. In this case, the spiral hose may further comprise a protection cover attached on the hollow flexible member, the protection cover having flexibility and forming the outer surface of the spiral hose. Preferably, the protection cover is made from at least one of polyethylene tarpaulin and soft polyethylene.

Further, the hard member has a hollow sectional shape, and the reinforcement member is a flexible lamination fixed to an upper surface of the soft member and filled in a lower portion of the spiral gap between turns of the hard spiral member. In this case, the flexible lamination has a plurality of holes, each of which is formed through a central portion of each turn of the flexible lamination in a sectional view of the flexible lamination. The spiral hose may further comprise a plurality of reinforcement cores inserted in said holes formed through the central portion of each turn of the flexible lamination. Also, the flexible lamination may be made from soft polyethylene, and the reinforcement cores are made from high-density polyethylene.

Also, the spiral hose may further comprise a soft cover having a band shape, the soft cover having lateral sides attached to upper portions of the hard member at both sides of the spiral gap.

The spiral hose may further comprise a reinforcement piece disposed across a center of a hollow space in the hard member.

In accordance with another aspect of the present invention, the present invention provides a watering hose utilizing polyethylene wound in a spiral shape to have flexibility, the watering hose comprising: a hard member made from polyethylene, which is wound in a spiral shape with a uniform spiral gap formed between turns of the hard member; and a soft member having a shape of a band and being formed of polyethylene tarpaulin, the soft member being disposed along the spiral gap while lateral edges of the soft member are fixed to portions of the hard member, which are disposed oppositely on both sides of the spiral gap.

In this case, the hard member may comprise a convex section protruding upward with angular corners and flanges extending laterally from lower ends of the convex section, and the lateral edges of the soft spiral member are attached to the flanges disposed oppositely on both sides of the spiral gap. In this case, the hard spiral member assembled with the soft member is bent and protrudes outward, and the flanges are integrally connected with each other, so as to form a base section which defines a closed space inside of the hard member.

The soft member may have side edges fixed to outer or inner surfaces of the flanges of the hard member. Also, the watering hose may further comprise a soft polyethylene film having a band shape, the soft polyethylene film being attached to an exposed portion of a lower surface of the base section and side portions of the soft member disposed at both sides of the exposed portion.

The watering hose may further comprise a coated film formed on a lower portion of the inner surface of the watering hose, so as to block gaps formed through a lower portion of a woven polyethylene fabric layer of the soft member or a coated film formed between the hard member and the soft member, so as to block gaps formed through a lower portion of a woven polyethylene fabric layer of the soft member.

In accordance with another aspect of the present invention, the present invention provides a spiral hose utilizing polyethylene, which includes a polyethylene member having a band shape, the polyethylene member comprising a convex portion and a concave portion adjacent to each other in a transverse sectional view of the polyethylene member, the polyethylene member being wound in a spiral shape while a plurality of the convex portions and a plurality of the concave portions are alternately engaged with and fused to each other, so as to form an integral spiral hose.

In this case, each of the convex portions and concave portions may have a rectangular shape in a transverse sectional view of the polyethylene member or the convex portion and the concave portion integrated with each other may form a shape like a sine wave in a transverse sectional view of the polyethylene member.

The spiral hose may further comprise a reinforcement band attached to at least two lower side ends of the concave portion disposed at either side of the convex portion so as to form a closed space inside of the convex portion. The reinforcement band may be made from at least one of polyethylene tarpaulin and soft polyethylene.

Further, the reinforcement band may be formed of a soft polyethylene layer and a polyethylene tarpaulin layer, the polyethylene tarpaulin layer having a width smaller than that of the soft polyethylene layer, the polyethylene tarpaulin layer being attached along a central portion of the soft polyethylene layer in a transverse view of the soft polyethylene layer so that edge portions of the soft polyethylene layer are exposed.

Also, the reinforcement band may be formed of a soft polyethylene layer and a polyethylene tarpaulin layer, the polyethylene tarpaulin layer having a width smaller than that of the soft polyethylene layer, the polyethylene tarpaulin layer being attached to an upper surface of a first side portion of the soft polyethylene layer in a transverse view of the soft polyethylene layer so that a second side portion of the soft polyethylene layer are exposed, the second side portion being attached to a lower surface of the first side portion in a transverse view of the soft polyethylene layer.

Moreover, the second side portion may be attached to the lower surface of the first side portion of the soft polyethylene layer while covering at least one adjacent concave portion, so that turns of the soft polyethylene layer overlapping on each other at each concave portion of the soft polyethylene layer form a lamination including at least two layers.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a perspective view of a spiral hose utilizing polyethylene according to an embodiment of the present invention;

FIG. 2 is a partial sectional view of a portion of the spiral hose shown in FIG. 2;

FIG. 3 is a partial sectional view of a spiral hose according to another embodiment of the present invention;

FIG. 4 is a partial sectional view of a spiral hose according to another embodiment of the present invention;

FIG. 5 is a partial sectional view of a spiral hose according to another embodiment of the present invention;

FIG. 6 is a partial sectional view of a spiral hose according to another embodiment of the present invention;

FIG. 7 is a partial sectional view of a spiral hose according to another embodiment of the present invention;

FIG. 8 is a perspective view of a spiral hose according to another embodiment of the present invention, which is used as a watering hose having spray holes;

FIG. 9 is a partial sectional view of FIG. 8;

FIG. 10 is a partial sectional view of a spiral hose according to another embodiment of the present invention;

FIG. 11 is a perspective view of a spiral hose according to another embodiment of the present invention;

FIG. 12 is a partial sectional view of FIG. 11;

FIG. 13 is a partial sectional view of a spiral hose according to another embodiment of the present invention;

FIG. 14 is a partial sectional view of a spiral hose according to another embodiment of the present invention;

FIG. 15 is a partial sectional view of a spiral hose according to another embodiment of the present invention;

FIG. 16 is a perspective view of a spiral hose according to another embodiment of the present invention;

FIG. 17 is a partial sectional view of FIG. 16;

FIG. 18 is a partial sectional view of a spiral hose according to another embodiment of the present invention;

FIG. 19 is a partial sectional view of a spiral hose according to another embodiment of the present invention;

FIG. 20 is a partial sectional view of a spiral hose according to another embodiment of the present invention;

FIG. 21 is a partial sectional view of a spiral hose according to another embodiment of the present invention;

FIG. 22 is a partial sectional view of a spiral hose according to another embodiment of the present invention;

FIG. 23 is a perspective view of a spiral hose according to another embodiment of the present invention;

FIG. 24 is a partial sectional view of FIG. 23;

FIG. 25 is a partial sectional view of a spiral hose according to another embodiment of the present invention;

FIGS. 26 to 37 are partial sectional views of spiral hoses according to other embodiments of the present invention;

FIG. 38 is a perspective view of a watering hose according to another embodiment of the present invention;

FIG. 39 is a partial sectional view of FIG. 38;

FIG. 40 is a partial sectional view of a watering hose according to another embodiment of the present invention;

FIG. 41 is a partial sectional view of a watering hose according to another embodiment of the present invention;

FIG. 42 is a partial sectional view of a watering hose according to another embodiment of the present invention;

FIG. 43 is a partial sectional view of a watering hose according to another embodiment of the present invention;

FIG. 44 is a partial sectional view of a watering hose according to another embodiment of the present invention;

FIG. 45 is a partial sectional view of a watering hose according to another embodiment of the present invention;

FIG. 46 is a perspective view of a watering hose according to another embodiment of the present invention;

FIG. 47 is a partial sectional view of FIG. 46;

FIG. 48 is a perspective view of a watering hose according to another embodiment of the present invention;

FIG. 49 is a sectional view taken along line A-A of FIG. 48;

FIG. 50 is a side sectional view of a watering hose according to another embodiment of the present invention;

FIG. 51 is a perspective view of a spiral hose according to another embodiment of the present invention;

FIG. 52 is a partial sectional view of a spiral hose according to another embodiment of the present invention;

FIG. 53 is a partial sectional view of a spiral hose according to another embodiment of the present invention;

FIG. 54 is a partial sectional view of a spiral hose according to another embodiment of the present invention;

FIG. 55 is a partial sectional view of a spiral hose according to another embodiment of the present invention; and

FIG. 56 is a partial sectional view of a spiral hose according to another embodiment of the present invention.

### BEST MODE FOR CARRYING OUT THE INVENTION

Reference will now be made in detail to the preferred embodiments of the present invention.

Embodiment 1

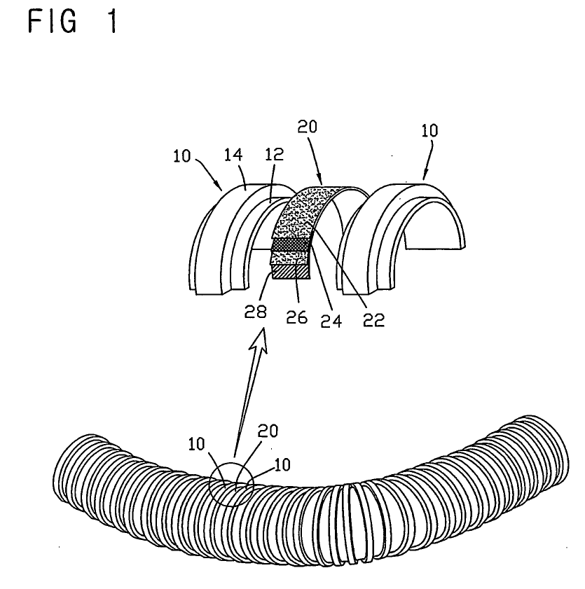

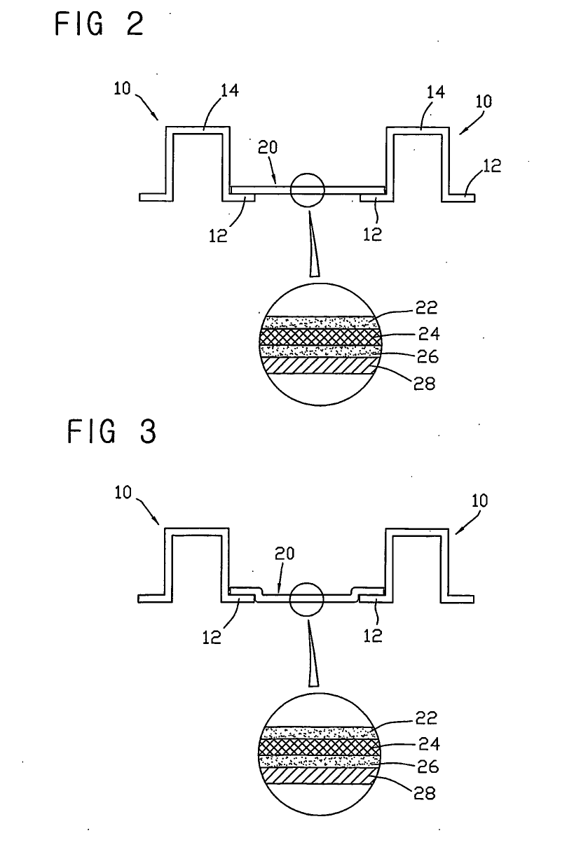

FIG. 1 is a perspective view of a spiral hose utilizing polyethylene according to the first embodiment of the present invention, and FIG. 2 is a sectional view of a portion of the spiral hose shown in FIG. 1. As shown, a spiral hose according to the present invention includes a hard spiral member 10 and a soft spiral member 20 assembled with each other.

The hard spiral member 10 is made from polyethylene and extends in a shape of a coil spring with a spiral gap having a uniform width between turns of the coil spring. In a sectional view, the hard spiral member 10 includes a convex section 14 protruding upward with angular corners and flanges 12 which extend laterally from lower ends of the convex section 14.

Additionally, the soft spiral member 20 has a shape of a band and is made of polyethylene tarpaulin formed by coating woven polyethylene fabrics. The soft spiral member 20 is disposed along the spiral gap between turns of the hard spiral member 10, while lateral edges of the soft spiral member 20 are fixed to the flanges 12 disposed oppositely on both sides of the spiral gap. In other words, the hard spiral member 10 and the soft spiral member 20 each extending in a spiral shape are attached to each other in the way described above, thereby forming the spiral hose according to the present invention.

In the spiral hose according to the present invention described above, the hard spiral member 10 made from polyethylene is bent and protrudes outward to form a space inside thereof, so that opposed inner surfaces of the spiral hose do not adhere to each other and the spiral hose can maintain its original shape even when a strong suction pressure is formed inside the spiral hose. Further, in the spiral hose, the soft spiral member 20 disposed in the gap between turns of the hard spiral member 10 is made of polyethylene tarpaulin having a high tensile strength and flexibility despite a small thickness, so that the spiral hose can sufficiently endure a strong pressure by water, etc., sucked by a pump.

The spiral hose according to the present invention can have the same resistance-to-pressure and flexibility as those of a PVC hose having a weight four times larger than that of the spiral hose. Therefore, the present invention reduces not only cost for manufacturing a hose but also manpower and time for installing or carrying the hose.

Polyethylene tarpaulin is material used mainly for tents. In polyethylene tarpaulin, only the tensile strengths of wefts and warps of a woven polyethylene fabric layer and the tensile strength of a polyethylene coating layer enough to endure the pressure of water flowing in the polyethylene coating layer, are considered as important factors. However, gaps between the wefts and warps, through which water may leak, are neglected. Therefore, a usual polyethylene tarpaulin implies a polyethylene tarpaulin made by coating a woven polyethylene fabric layer with a low-density polyethylene layer which has a tensile strength (which relates to the breaking point) of only 120 to 140 kg/cm².

In a spiral hose according to the present invention, the polyethylene tarpaulin, the material of the soft spiral member 20, may be a usual tarpaulin formed by coating a low-density polyethylene layer 22 or 26 on at least one surface of a woven polyethylene fabric layer 24. However, in the case where the spiral hose is made of the polyethylene tarpaulin formed by coating only the low-density polyethylene layer 22 or 26 on the woven polyethylene fabric layer 24, the coated low-density polyethylene layer 22 or 26 may be torn by the internal pressure of the spiral hose, so that the transferred water may leak through the gaps between wefts and warps of the woven polyethylene fabric layer 24. Therefore, it is preferred that the soft spiral member 20 is made of a polyethylene tarpaulin formed by coating a low-density polyethylene layer 26 and a high-density polyethylene layer 28 in sequence on at least one surface of the woven polyethylene fabric layer 24.

The high-density polyethylene layer 28 implies an ordinary high-density polyethylene tarpaulin having a density of about 0.941 to 0.965 g/cm² and a tensile strength of only 330 to 340 kg/cm², which is 2.5 times larger than that of the low-density polyethylene tarpaulin, thereby having nearly the same breaking point as that of the woven polyethylene fabric layer 24, enough to endure the pressure of transferred water when the high-density polyethylene layer 28 has been coated on the woven polyethylene fabric layer 24.

In coating the high-density polyethylene layer 28 as described above, the low-density polyethylene layer 26 having a low melting point is coated on one surface of the woven polyethylene fabric layer 24, and then the high-density polyethylene layer 28 is coated on the other surface of the woven polyethylene fabric layer 24. This is because, when the high-density polyethylene layer 28, having as a high melting point as the woven polyethylene fabric layer 24 has, is coated directly on an outer surface of the woven polyethylene fabric layer 24, the coated surface may come off instead of being in tight contact with the surface of the woven polyethylene fabric layer 24.

The soft spiral member 20 described above, as shown in FIGS. 1 and 2, may be fixed to outer surfaces of the flanges 12 of the hard spiral member 10. In this case, it is preferred that the inner surface of the soft spiral member 20, which is in tight contact with the outer surfaces of the flanges 12 of the hard spiral member 10, is formed of a high-density polyethylene coating layer capable of sufficiently enduring the internal pressure of the hose.

In the hose shown in FIG. 3, lateral edges of the soft spiral member 20 are fixed to the outer surfaces of the flanges 12 of the hard spiral member 10 while a central portion of the soft spiral member 20 is bent downward so that the lower surface of the soft spiral member 20 is level with the lower surface of the hard spiral member 10. In this case, since the lower surface of the soft spiral member 20 is level with the lower surface of the hard spiral member 10, the pressure of transferred water applied to the soft spiral member 20 can be reduced.

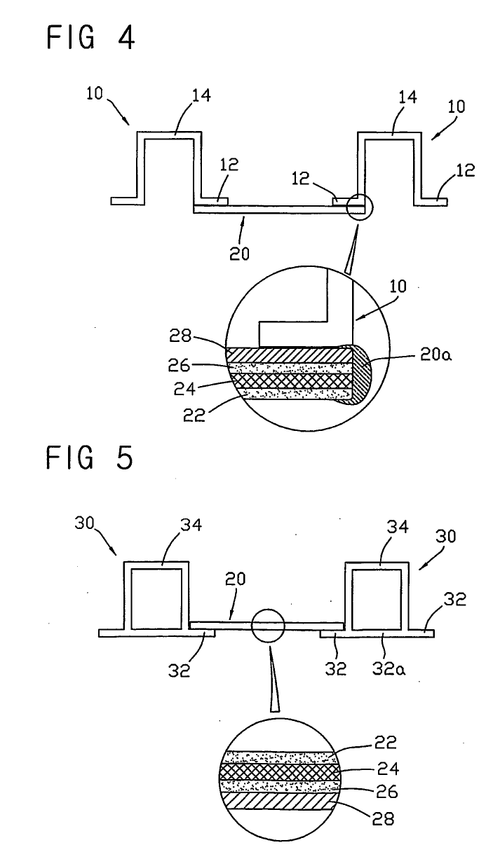

Further, as shown in FIG. 4, side edges of the soft spiral member 20 according to the present invention may be attached to inner surfaces of the flanges 12 of the hard spiral member 10 while the soft spiral member 20 is disposed in the spiral gap between the flanges 12. In this case, it is preferred that the high-density polyethylene layer 28 forms the upper surface in contact with the inner surfaces of the flanges 12 of the hard spiral member 10.

Further, in the case where side ends of the soft spiral member 20 made of the polyethylene tarpaulin are exposed to the inner surface of the hose, there may occur a sweating phenomenon, that is, water may leak through fine gaps between the texture of the woven polyethylene fabric layer 24 to the outside of the hose. Therefore, in order to prevent this sweating phenomenon, side ends of the polyethylene tarpaulin forming the soft spiral member 20 may be preferably coated with an adhesive or sealant material to form watertight ends 20a. As described above, in the case where side ends of the soft spiral member 20 exposed to the interior space of the spiral hose are formed as the watertight ends 20a, water is basically prevented from leaking through the woven polyethylene fabric layer 24, thereby preventing the sweating phenomenon, that is, preventing water from leaking out of the hose, even when a high pressure is formed in the spiral hose.

The watertight end 20a can be formed not only by coating the adhesive material on the side ends of the polyethylene tarpaulin forming the soft spiral member 20 as described above, but also by various other ways, for example, by folding the side ends of the polyethylene tarpaulin forming the soft spiral member 20 upward and then attaching them to the lower surfaces of the flanges 12 of the hard spiral member 10, thereby preventing them from being exposed to the inner space of the hose.

Embodiment 2

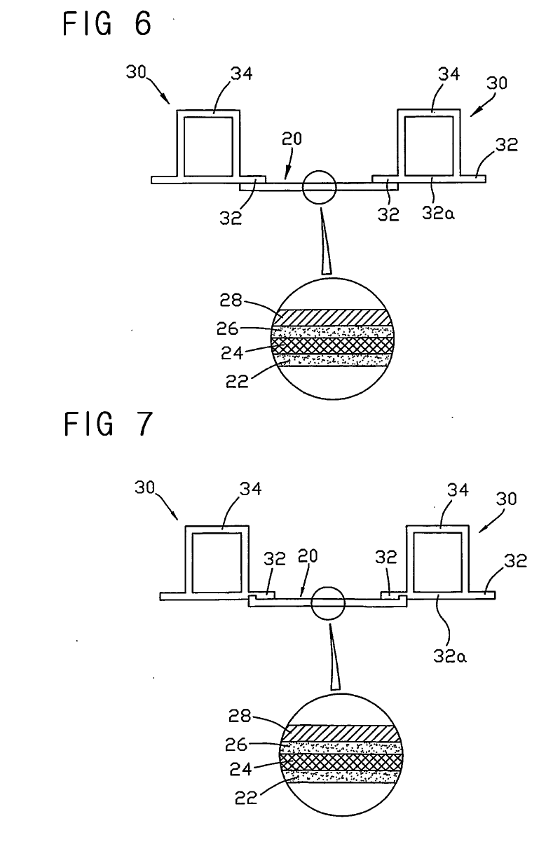

FIGS. 5 and 6 are sectional views of a main portion of a spiral hose according to another embodiment of the present invention, respectively. As shown, a hard spiral member 30 includes a convex section 34 which protrudes upward with angular corners to form a rectangular space in the convex section 34 and flanges 32 which extend laterally from lower ends of the convex section 34. This construction enables the hard spiral member 30 to have a firmer construction, thereby preventing opposed inner surfaces of the hose from adhering to each other and enabling the shape of the hose to be maintained even when the pressure of the water transferred through the hose is very large.

In the case of the hard spiral member 30 having the above-mentioned construction-also, as shown in FIGS. 5 and 6, side edges of the soft spiral member 20 may be attached to either the inner surfaces or the outer surfaces of the flanges 32 of the hard spiral member 30. In this case, it is preferred that the high-density polyethylene layer 28 of the soft spiral member 20 forms the surface attached to the flanges 32 of the hard spiral member 30. Further, it is also preferred that, when the side edges of the soft spiral member 20 are attached to the inner surface of the hard spiral member 30, side ends of the soft spiral member 20 are coated to be watertight, as in the previous embodiment.

FIG. 7 is a sectional view showing another assembly between the hard spiral member 30 and the soft spiral member 20 according to another embodiment of the present invention, in which grooves are formed longitudinally along side portions of the lower surface of the hard spiral member 30 and side edges of the soft spiral member 20 are inserted in the grooves, so that side ends of the soft spiral member 20 are sealed to be watertight.

Embodiment 3

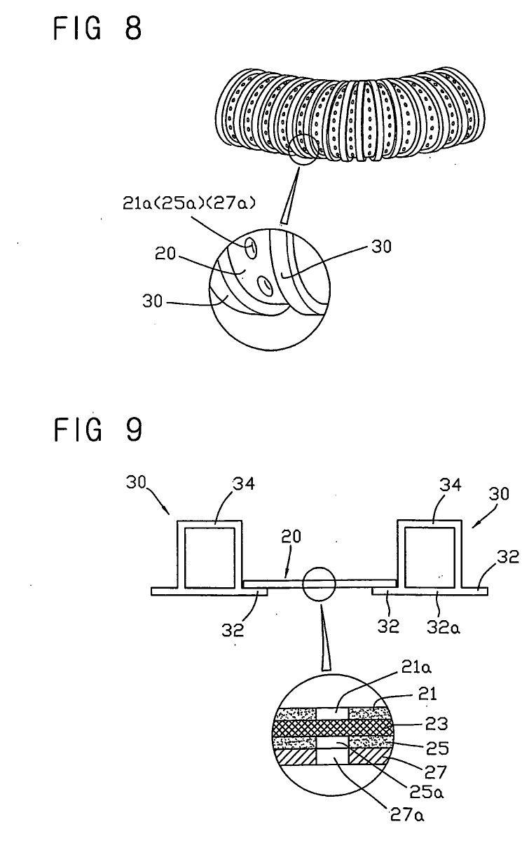

FIGS. 8 and 9 show a spiral hose according to another embodiment of the present invention, which is used as a watering hose having spray holes.

That is, the soft spiral member 20 is formed by coating a woven polyethylene fabric layer 23 with polyethylene coating layers 21, 25, and 27, each of which has a plurality of spray holes 21a, the polyethylene coating layer 25a, and the polyethylene coating layer 27a. In this case, water can be exhausted out of or introduced into the spiral hose through the gaps between the wefts and warps of the woven polyethylene fabric layer and through the spray holes 21a, 25a, and 27a formed through each of the polyethylene coating layers, so that the spiral hose can function as a watering hose.

Although the above description is given to the case where the spiral hose according to the present invention is used as a hose through which water is transferred, the spiral hose according to the present invention can be utilized also as a duct through which gas passes. In the latter case, in consideration that the duct may be installed while being bent more than 90°, it is preferred that each interval between wefts and between warps has a wide distance of 5 to 20 mm so that the soft spiral member 20 formed of the polyethylene tarpaulin has a high flexibility along with at least necessary strength.

Embodiment 4

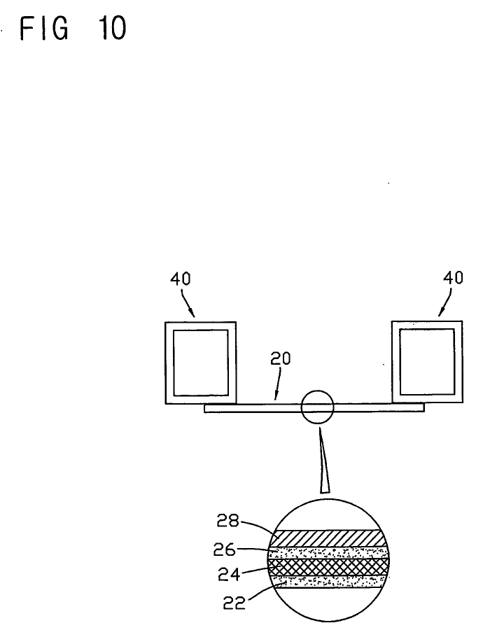

Further, although each of the spiral hoses according to the embodiments described above has flanges formed at side edges of the hard spiral member, FIG. 10 shows another embodiment of the present invention, in which a hard spiral member 40 has a hollow polygonal section without the flanges and side edges of the soft spiral member 20 may be attached to side portions of the lower surface of the hard spiral member 40. Besides this, various modifications may be employed, for example, the hard spiral member 40 may have a solid polygonal section instead of the hollow polygonal section.

Meanwhile, in the spiral hose described above, in which the soft spiral member is attached to the inner surface of the hard spiral member, a separate labor of coating side ends of the soft spiral member for achieving water-tightness of the side ends thereof is indispensable, and the pressure of fluid flowing inside of the spiral hose or the shaking of the spiral hose itself may separate the hard spiral member and the soft spiral member from each other.

Further, in the case where the soft spiral member is attached to the outer surface of the hard spiral member also, in consideration of the characteristics of the spiral hose that it may be frequently deformed at various angles, the hard spiral member and the soft spiral member may be still separated from each other. Embodiments capable of overcoming these disadvantages will be described hereinafter.

Embodiment 5

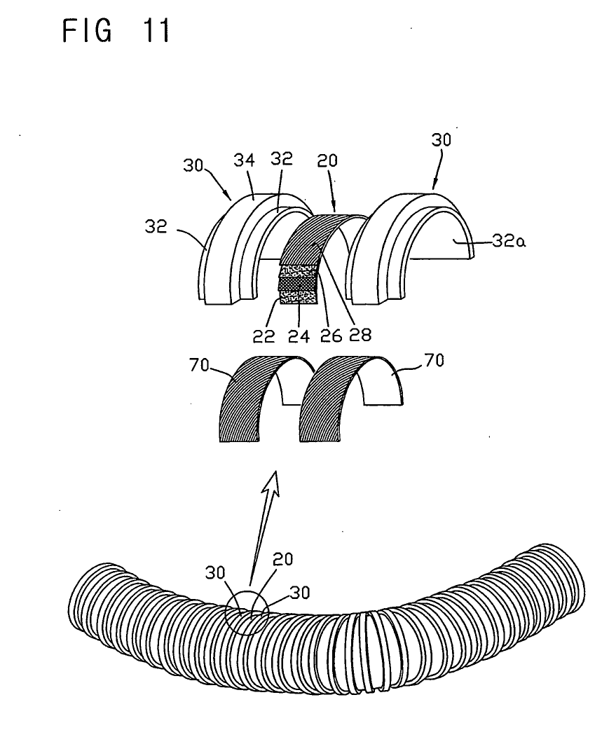

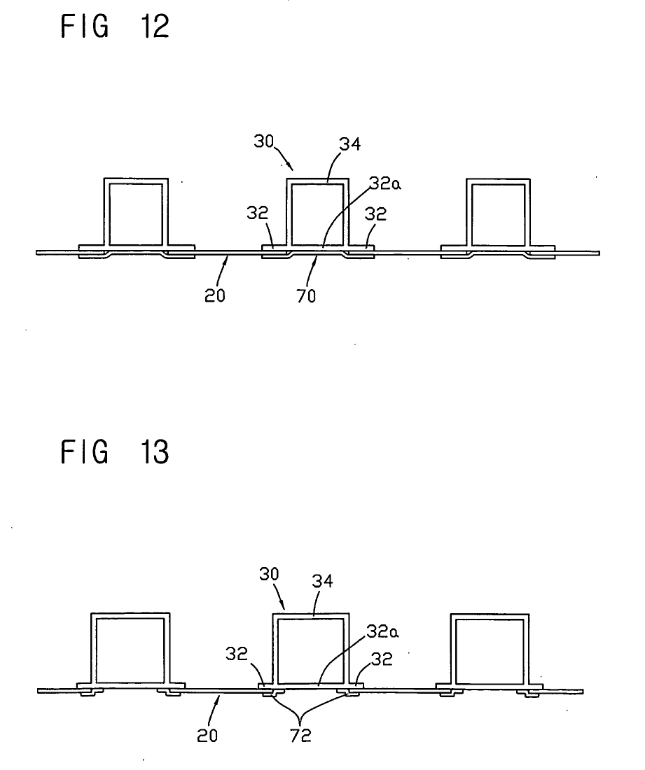

FIG. 11 is a perspective view of a spiral hose utilizing polyethylene according to another embodiment of the present invention, and FIG. 12 is a sectional view of a portion of the spiral hose shown in FIG. 11. As shown, the spiral hose according to the present embodiment includes not only the hard spiral member 30 and the soft spiral member 20 attached together but also a fastening band 70 strengthening attachment between the hard spiral member 30 and the soft spiral member 20.

That is, the hard spiral member 30 is made from polyethylene and extends in a shape of a coil spring with a spiral gap having a uniform width between turns of the coil spring. Further, in a sectional view in FIG. 12, the hard spiral member 30 includes a flat base section 32a, the convex section 34 which protrudes upward from the base section 32a with angular corners while forming a closed space in the convex section 34, and the flanges 32 extending laterally from side ends of the base section 32a.

The soft spiral member 20 has a shape of a band and is made of polyethylene tarpaulin. The soft spiral member 20 is disposed along the spiral gap between turns of the hard spiral member 30, while lateral edges of the soft spiral member 20 are fixed to the flanges 32 disposed oppositely on both sides of the spiral gap. In other words, the hard spiral member 30 and the soft spiral member 20 each extending in a spiral shape are attached to each other in the way described above, thereby forming the spiral hose according to the present invention.

In a spiral hose according to the present invention, the polyethylene tarpaulin, the material of the soft spiral member 20, may be a common tarpaulin formed by coating a low-density polyethylene layer 22 or 26 on at least one surface of the woven polyethylene fabric layer 24. However, in the case where the spiral hose is made of the polyethylene tarpaulin formed by coating only the low-density polyethylene layer 22 or 26 on the woven polyethylene fabric layer 24, the coated low-density polyethylene layer 22 or 26 may be torn by the internal pressure of the spiral hose, so that the transferred water may leak through the gaps between wefts and warps of the woven polyethylene fabric layer 24. Therefore, it is preferred that the soft spiral member 20 is made of a polyethylene tarpaulin formed by coating a low-density polyethylene layer 26 and a high-density polyethylene layer 28 in sequence on at least one surface of the woven polyethylene fabric layer 24.

The high-density polyethylene layer 28 implies an ordinary high-density polyethylene tarpaulin having a density of about 0.941 to 0.965 g/cm² and a tensile strength of only 330 to 340 kg/cm², which is 2.5 times larger than that of the low-density polyethylene tarpaulin, thereby having nearly the same breaking point as that of the woven polyethylene fabric layer 24, enough to endure the pressure of transferred water when the high-density polyethylene layer 28 has been coated on the woven polyethylene fabric layer 24.

In coating the high-density polyethylene layer 28 as described above, the low-density polyethylene layer 26 having a low melting point is coated on one surface of the woven polyethylene fabric layer 24, and then the high-density polyethylene layer 28 is coated on the other surface of the woven polyethylene fabric layer 24. This is because, when the high-density polyethylene layer 28, having as a high melting point as the woven polyethylene fabric layer 24 has, is coated directly on an outer surface of the woven polyethylene fabric layer 24, the coated surface may come off instead of being in tight contact with the surface of the woven polyethylene fabric layer 24.

Further, the fastening band 70 has a shape of a band and is made from resin. The fastening band 70 is attached onto and covers over both an exposed portion of the lower surface of the flange 32 of the hard spiral member 30 and side edges of the soft spiral member 20. In this case, it is preferred that the fastening band 70 is made from soft resin such as soft polyethylene, thereby preventing the flexibility of the soft spiral member 20 from being deteriorated by the attached fastening band 70.

In the spiral hose having the construction described above according to the present embodiment, in like manner as in the previous embodiments, the assembling construction between the hard spiral member 30 and the soft spiral member 20 enables the spiral hose to not only be light but also to have a high pressure and strong tensile strength and resistance-to-pressure. Moreover, the fastening band 70 tightly covering the exposed portion of the lower surface of the flange 32 and side edges of the soft spiral member 20 naturally seals the side ends of the soft spiral member 20, thereby eliminating a separate labor of coating the side ends of the soft spiral member 20. Also, the fastening band 70 increases the cohesive force between the hard spiral member 30 and the soft spiral member 20, thereby efficiently preventing the hard spiral member 30 and the soft spiral member 20 from being separated from each other by internal pressure or shaking of the spiral hose itself.

FIG. 13 is an enlarged sectional view of a portion of a spiral hose utilizing polyethylene according to another embodiment of the present invention, in which a fastening band 72 is attached on each joint portion between the flanges 32 of the hard spiral member 30 and side edges of the hard spiral member 30.

Embodiment 6

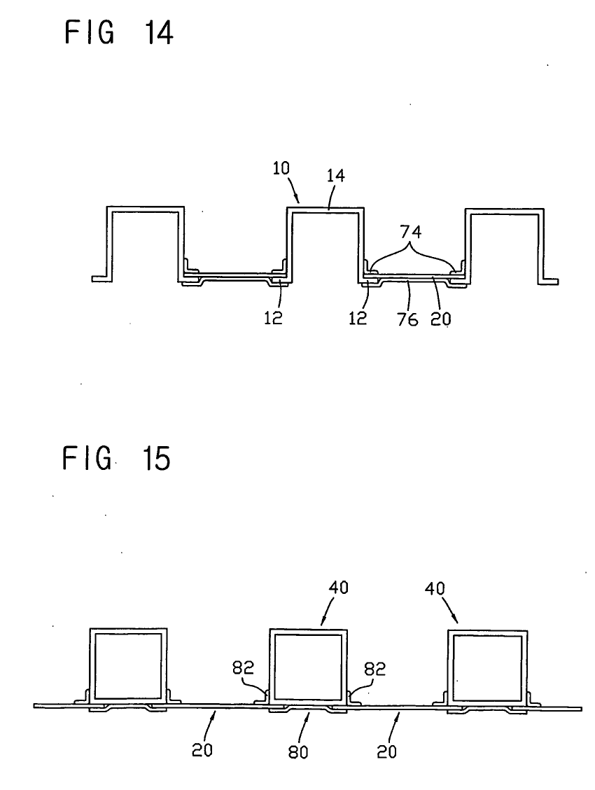

FIG. 14 is an enlarged sectional view of a portion of a spiral hose utilizing polyethylene according to another embodiment of the present invention, which shows fastening bands 74 and 76 for reinforcing the attachment between the flanges 12 of the hard spiral member 10 and side edges of the soft spiral member 20 fused to and attached on the flanges 12. In the drawing, reference numeral 14 designates a convex section forming a external shape of the spiral hose.

That is, in the case where the soft spiral member 20 is attached to the upper surface of the flanges 12 of the hard spiral member 10 as described above, the fastening band 74 may be attached in such a manner that the fastening band 74 covers over lower portions of side wall surfaces of the hard spiral member 10 and side edges of the soft spiral member 20, and the fastening band 76 may be attached in such a manner that the fastening band 76 covers over both the flanges 12 of the hard spiral member 10 and the soft spiral member 20 attached to the upper surfaces of the flanges 12 of the hard spiral member 10. Of course, the spiral hose according to the present invention may employ both of or one selected from among the fastening bands 74 and 76.

Embodiment 7

Although each of the spiral hoses according to the embodiments described above has flanges formed at side edges of the hard spiral member, FIG. 15 shows a portion of a spiral hose according to another embodiment of the present invention, in which the hard spiral member 40 has a hollow polygonal section without the flanges and side edges of the soft spiral member 20 may be attached to side portions of the lower surface of the hard spiral member 40.

That is, in the spiral hose having the construction described above, a fastening band 80 may be attached in such a manner that the fastening band 80 covers over not only side edges of the soft spiral member 20 attached to side edges of the lower surface of the hard spiral member 40 but also a remaining portion of the lower surface of the hard spiral member 40, and/or a fastening band 82 may be attached in such a manner that the fastening band 82 covers over lower portions of side wall surfaces of the hard spiral member 40 and side edges of the soft spiral member 20.

Meanwhile, the construction as described above may be employed in a polyethylene spiral hose utilized as a gas duct or sewage pipe. In this case, in consideration that the duct or sewage pipe may be installed while being bent more than 90°, it is preferred that each interval between wefts and between warps has a wide distance of 5 to 20 mm so that the polyethylene tarpaulin forming the soft spiral member 20 has a high flexibility along with at least necessary strength.

In the meantime, in order to prevent the spiral hose as described above from being broken in the cold winter season, the spiral hose should be wrapped by a heat insulation coat. However, the spiral and flexural shape of the outer surface of the spiral hose causes the labor of wrapping the heat insulation coat around the spiral hose to be difficult and time-consuming. Further, according to passage of time, the heat insulation coat wrapped around the spiral hose may be loosened or even partially separated from the spiral hose, so that it is difficult to anticipate the heat insulation coat having a long-term continuous heat insulation effect and, furthermore, the external appearance of the spiral hose may look messy, thereby requiring the heat insulation coat to be frequently replaced. Hereinafter, embodiments for overcoming such disadvantages will be described.

Embodiment 8

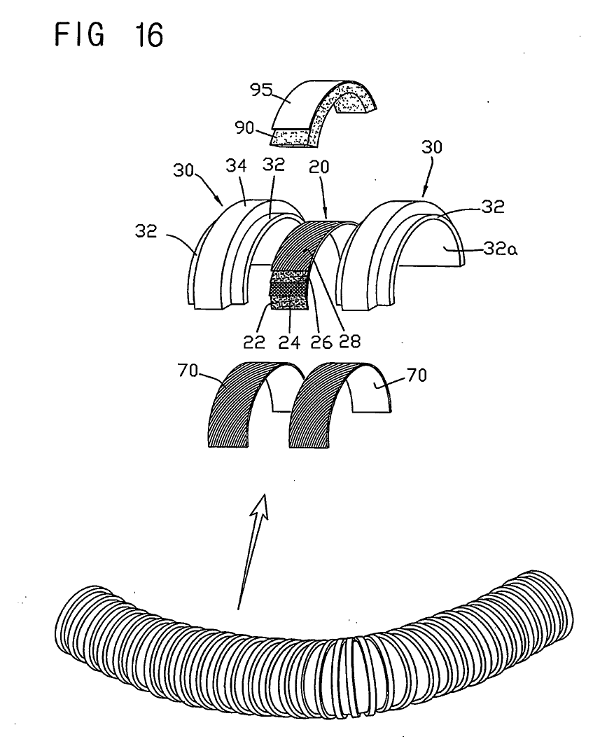

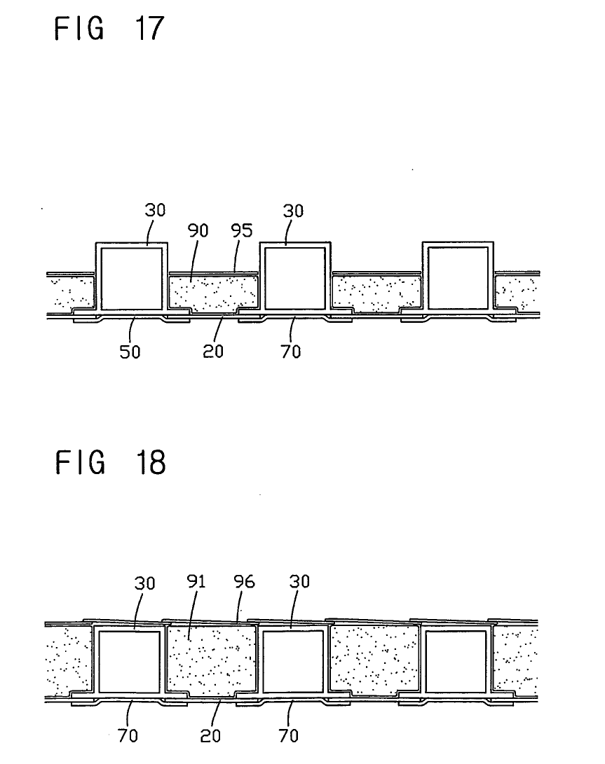

FIG. 16 is a perspective view of a spiral hose utilizing polyethylene according to another embodiment of the present invention, and FIG. 17 is a sectional view of a portion of the spiral hose shown in FIG. 16. As shown, the spiral hose according to the present embodiment includes not only the hard spiral member 30 and the soft spiral member 20 attached together but also a heat-insulation foam 90 for keeping the spiral hose warm.

That is, the hard spiral member 30 is made from hard resin and extends in a shape of a coil spring with a spiral gap having a uniform width between turns of the coil spring. Further, in a sectional view of FIG. 17, the hard spiral member 30 includes a flat base section 32a, the convex section 34 which protrudes upward from the base section 32a with angular corners while forming a closed space in the convex section 34, and the flanges 32 extending laterally from side ends of the base section 32a.

The soft spiral member 20 has a shape of a band made of resin. The soft spiral member 20 is disposed along the spiral gap between turns of the hard spiral member 30, while lateral edges of the soft spiral member 20 are fixed to the flanges 32 disposed oppositely on both sides of the spiral gap. In other words, the hard spiral member 30 and the soft spiral member 20 each extending in a spiral shape are attached to each other in the way described above, thereby forming a spiral hose having a spiral groove according to the present invention.

Further, the heat-insulation foam 90 is filled in the spiral groove formed on the outer surface of the spiral hose and fixed to the upper surface of the soft spiral member 20, thereby insulating and warming the spiral hose.

The spiral hose having the construction described above according to the present embodiment necessarily has a high tensile strength and flexibility and a strong resistance-to-pressure as do the spiral hoses according to the previous embodiments. Moreover, in the spiral hose, the thick hard spiral member 30 has an adiabatic characteristic due to its own thickness while the thin soft spiral member 20 having no adiabatic characteristic is insulated from heat by the foam 90 attached onto the soft spiral member 20, so as to prevent heat from being transferred between the interior and exterior of the spiral hose, thereby enabling the spiral hose to have an excellent heat-keeping effect.

In addition, in the spiral hose having the construction described above, the foam 90 is integrally fixed in the spiral groove formed on the soft spiral member 20. Therefore, the foam 90 is not loosened or separated from the soft spiral member 20 even when the spiral hose has been used for long time, and the external appearance of the spiral hose can be always maintained clean and tidy, thereby largely increasing the marketability of the spiral hose.

Meanwhile, a Biaxially Oriented Polypropylene (BOPP) film, a Polyethylene Terephthalate (PET) film, or a high-density Polyethylene (HDPE) film may be utilized as the hard spiral member 30. Especially, the HDPE film implies an ordinary high-density polyethylene film having a density of about 0.941 to 0.965 g/cm² and a tensile strength of only 330 to 340 kg/cm², which is 2.5 times larger than that of the low-density polyethylene (LDPE) film, thereby having nearly the same breaking point as that of the woven polyethylene fabric layer 24, which enables the spiral hose to effectively maintain its shape.

In the spiral hose described above, the soft spiral member may employ a low-density polyethylene (LDPE) film, a casting polypropylene (CPP) film, a thermoplastic elastomer, a polyethylene tarpaulin, or silicon, which can provide the spiral hose with flexibility. Especially, the polyethylene tarpaulin is formed by coating LDPE and/or HDPE on at least one surface of a woven polyethylene fabric and has a very high breaking point in comparison with its thickness, so that the polyethylene tarpaulin can be preferably used in manufacturing a high-pressure hose. FIG. 16 shows a soft spiral member 20 made of a polyethylene tarpaulin formed by laminating the low-density polyethylene layer 22, the woven polyethylene fabric layer 24, the low-density polyethylene layer 26, and the high-density polyethylene layer 28, in sequence upward from the bottom of the soft spiral member 20.

In the spiral hose described above, which includes the hard spiral member 30 made from HDPE, the soft spiral member 20 made from polyethylene tarpaulin, and the foam 90 made from polyethylene foam, a strong cohesive force between the hard spiral member 30, the soft spiral member 20, and the foam 90 can be obtained due to the same material being used in all of them.

Meanwhile, in the spiral hose having the construction described above, the fastening band 70 may be so attached as to cover over both an exposed portion of the lower surface of the flange 32 of the hard spiral member 30 and side edges of the soft spiral member 20, thereby water-tightly sealing side ends of the soft spiral member 20 and increasing the cohesive force between the hard spiral member 30 and the soft spiral member 20. In this case, it is preferred that the fastening band 70 is made from soft resin such as soft polyethylene, thereby preventing the flexibility of the soft spiral member 20 from being deteriorated by the attached fastening band 70.

Further, an aluminum foil 95 usually utilized as an adiabatic or heat-insulating material may be attached, in a spiral shape, along and to the upper surface of the foam 90 fixed to the upper surface of the soft spiral member 20 of the spiral hose, thereby further improving the adiabatic or heat-insulating function of the spiral hose.

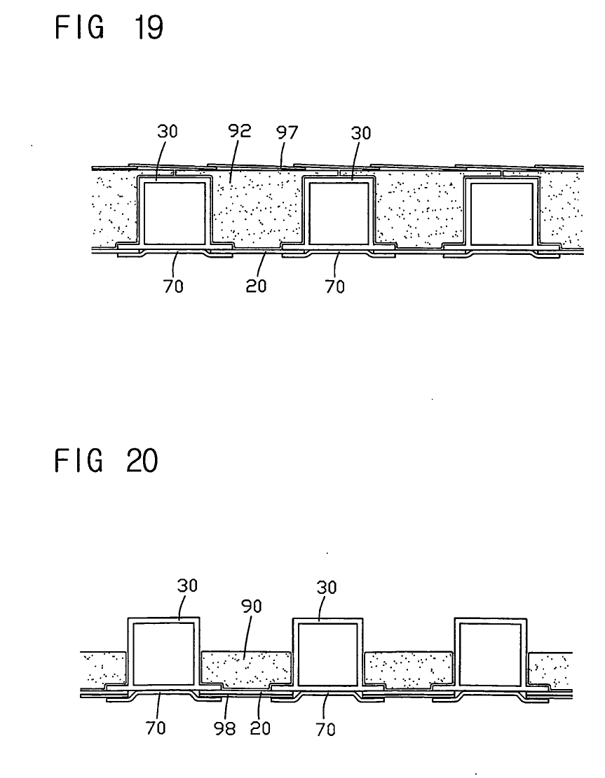

FIGS. 17 to 19 show various examples of attachment between heat-insulation foams 90 to 92 and aluminum foils 95 to 97. In the spiral hose shown in FIG. 17, a heat-insulation foam 90 and an aluminum foil 95 are sequentially attached in the groove formed on the soft spiral member 20. In the spiral hose shown in FIG. 18, a heat-insulation foam 91 is completely filled in the groove on the soft spiral member 20, and an aluminum foil 96 is so attached as to completely cover the upper surfaces of the hard spiral member 30 and the foam 91 while extending in a spiral shape. Further, in the spiral hose shown in FIG. 19, a heat-insulation foam 92 is not only completely filled in the groove with the soft spiral member 20 but also covers over the hard spiral member 30, and the aluminum foil 96 is so attached as to completely cover the upper surface of the foam 92 while extending in a spiral shape, thereby completely covering the outer surface of the spiral hose.

Embodiment 9

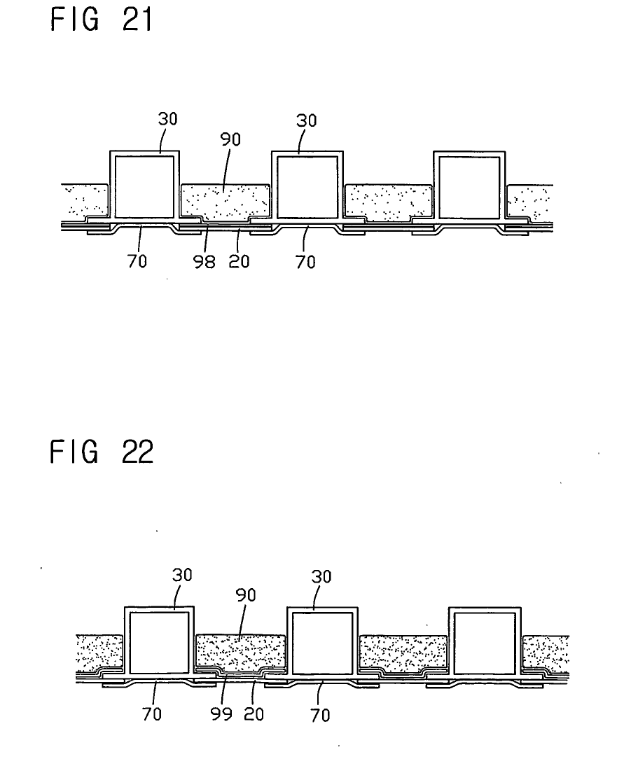

FIGS. 20 and 21 show spiral hoses according to other embodiments of the present invention, in which an aluminum foil 98 is attached to one surface of the soft spiral member 20 attached to side edges of an inner surface of the hard spiral member 30 along a spiral gap formed between turns of the hard spiral member 30. That is, the aluminum foil 98 may be attached to an outer surface and/or an inner surface of the soft spiral member 20, so that the soft spiral member 20, which has a weak adiabatic function, can be insulated from heat doubly by the foam 90 and the aluminum foil 98, thereby improving the heat-keeping capability of the spiral hose.

FIG. 22 shows a spiral hose according to other embodiments of the present invention, in which an aluminum foil 99 is first attached to an upper surface of the soft spiral member 20 and the foam 90 is then attached to an upper surface of the aluminum foil 99. In the spiral hose having the construction described above also, the soft spiral member 20, which has a weak adiabatic function, can be insulated from heat doubly by the foam 90 and the aluminum foil 99, thereby improving the heat-keeping capability of the entire spiral hose.

In the spiral hose described above, the soft spiral member having a lower strength may be easily depressed toward the inner space of the spiral hose by an external force. Especially, when the spiral hose described above is used as a suction hose, the pressure of sucked fluid may repeatedly fold and unfold the soft spiral member and repeatedly suck and separate the spaced turning portions of the hard spiral member to and from each other, so that the spiral hose may violently shake while repeatedly contracting and expanding and may frequently escape its originally installed position. This shaking of the spiral hose may apply repetitive impact to attachment portions between the hard and soft spiral members and scratch the surface of the spiral hose, thereby shortening the lifespan of the spiral hose.

Further, when the spiral hose having the hollow hard spiral member is used as a sewage pipe, the hollow hard spiral member may also be pressed and deformed to decrease the sectional area of the spiral hose, thereby weakening the strength of the sewage pipe. In the worse case, the deformed hard spiral member may be depressed inward of the spiral hose, thereby decreasing the draining function of the hose. Spiral hoses according to other embodiments of the present invention in order to overcome these disadvantages will be described hereinafter.

Embodiment 10

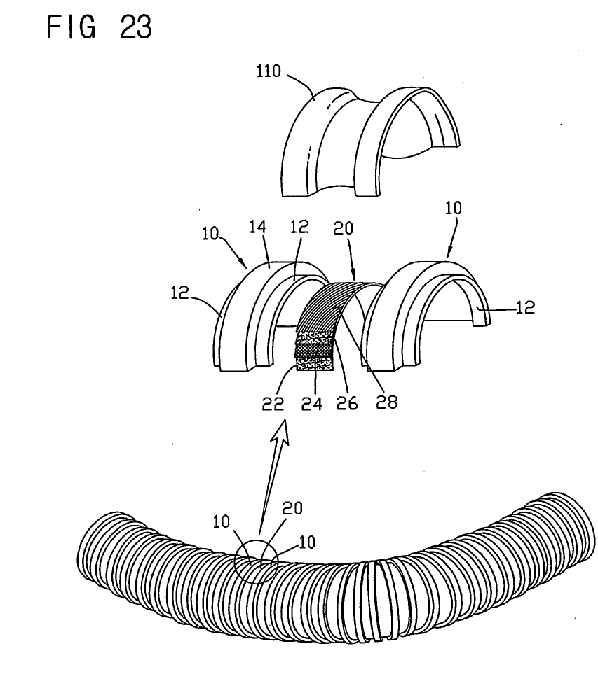

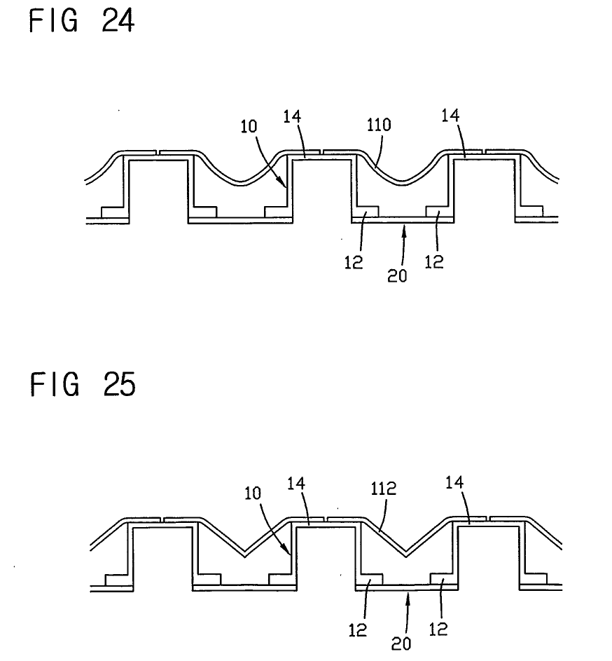

FIG. 23 is a perspective view of a spiral hose utilizing polyethylene according to another embodiment of the present invention, and FIG. 24 is a sectional view of a portion of the spiral hose shown in FIG. 23. As shown, the spiral hose according to the present embodiment includes the hard spiral member 10, the soft spiral member 20, and a reinforcement member.

The hard spiral member 10 is made from hard resin and extends in a shape of a coil spring which has a spiral gap having a uniform width between turns of the coil spring. In its sectional view, the hard spiral member 10 includes the convex section 14 protruding upward (that is, outward from the body of the spiral hose) with angular corners and the flanges 12 extending laterally from lower ends of the convex section 14.

The soft spiral member 20 has a shape of a band made of resin. The soft spiral member 20 is disposed along the spiral gap between turns of the hard spiral member 10, while lateral edges of the soft spiral member 20 are fixed to the flanges 12 disposed at both sides of the spiral gap and opposed to each other. In other words, the hard spiral member 10 and the soft spiral member 20 each extending in a spiral shape are attached to each other in the way described above, thereby forming a spiral hose having a spiral groove according to the present invention.

Further, the reinforcement member is a member made from soft material, which maintains uniform turning pitches of the hard spiral member 10 in the longitudinal direction of the spiral hose. The reinforcement member is disposed above the soft spiral member 20 and side edges of the reinforcement member are attached to adjacent side portions of the upper surface of the hard spiral member 10 through a way of thermal fusion or the like.

In the spiral hose having the construction described above, the reinforcement member is disposed above the soft spiral member 20 while continuously connecting adjacent side portions of the upper surface of the hard spiral member 10, so as to reinforce the strength of the soft spiral member 20, thereby preventing the soft spiral member 20 from being depressed toward the inner space of the spiral hose by an external force. Further, the reinforcement member firmly maintains the spacings between the turns of the hard spiral member 10, so as to prevent the hose from contracting and expanding in the longitudinal direction of the hose even when liquid is sucked through the hose, thereby preventing the hose from escaping its original position and preventing it from being scratched, and also thereby largely improving the durability of the hose.

Meanwhile, a Biaxially Oriented Polypropylene (BOPP) film, a Polyethylene Terephthalate (PET) film, or a high-density Polyethylene (HDPE) film may be utilized as the hard spiral member 10. Especially, the HDPE film implies an ordinary high-density polyethylene film having a density of about 0.941 to 0.965 g/cm² and a tensile strength of only 330 to 340 kg/cm², which is 2.5 times larger than that of the low-density polyethylene (LDPE) film, thereby having nearly the same breaking point as that of the woven polyethylene fabric layer 24, which enables the spiral hose to effectively maintain its shape.

The soft spiral member 20 is a means for providing the spiral hose with flexibility. A low-density polyethylene (LDPE) film, a casting polypropylene (CPP) film, a thermoplastic elastomer, a polyethylene tarpaulin, or silicon may be employed as the soft spiral member 20. Especially, when the hard spiral member 10 is formed of a single layer of HDPE, it is preferred that the soft spiral member 20 is formed of a single layer of polyethylene tarpaulin or laminated multi-layers of soft polyethylene/polyethylene tarpaulin.

The polyethylene tarpaulin is formed by coating LDPE and/or HDPE on at least one surface of a woven polyethylene fabric and has a very high breaking point in comparison with its thickness, so that the polyethylene tarpaulin can be preferably used in manufacturing a high-pressure hose. FIG. 23 shows a soft spiral member 20 made of a polyethylene tarpaulin formed by laminating the low-density polyethylene layer 22, the woven polyethylene fabric layer 24, the low-density polyethylene layer 26, and the high-density polyethylene layer 28 in sequence upward from the bottom of the soft spiral member 20.

In the spiral hose described above, which includes the hard spiral member 10 made from HDPE, the soft spiral member 20 made from polyethylene tarpaulin and/or soft polyethylene, and a reinforcement member made from polyethylene, strong cohesive force between the hard spiral member 10, the soft spiral member 20, and the reinforcement member can be obtained due to the same material being used in all of them.

Meanwhile, in the spiral hose having the construction described above, the reinforcement member may be a flexure cover 110 or 112, which is disposed above the soft spiral member 20 while its side edges are attached to adjacent side portions of the upper surface of the hard spiral member 10 and its central portion in the transverse direction is concave downward, as shown in FIG. 24 and the polyethylene coating layer 25. In this case, the central portion of the flexure cover 110 or 112 in its transverse direction may be smoothly curved downward as shown in FIG. 24 or sharply bent downward as shown in FIG. 25.

Embodiment 11

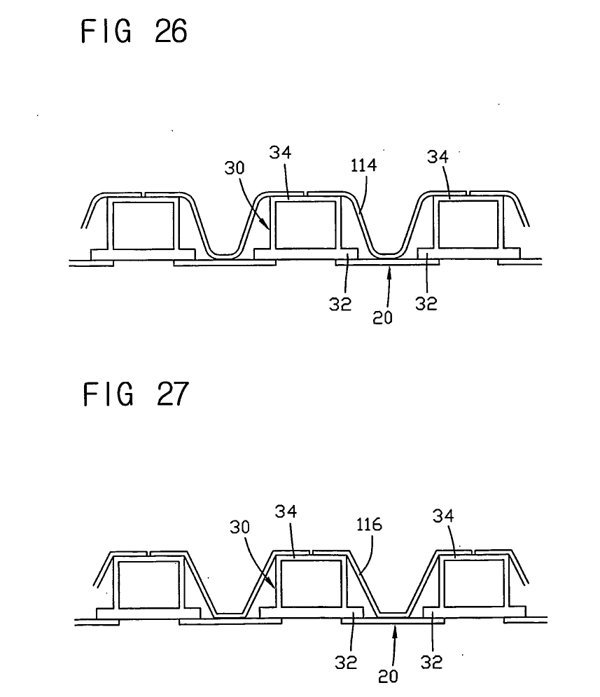

FIGS. 26 to 28 are partial sectional views of spiral hoses according to other embodiments of the present invention, each of which includes a hollow hard spiral member 30 and a soft spiral member 20 assembled together, and a reinforcement member attached to the assembled hard and soft spiral members 30 and 20.

That is, a flexure cover 114, 116, or 118 is disposed above and along the soft spiral member 20. Side edges of the flexure cover 114, the flexure cover 116, or the flexure cover 118 are attached to side portions of an upper surface of the hard spiral member 30 disposed at either side of the soft spiral member 20, and a central portion of the flexure cover 114, the flexure cover 116, or the flexure cover 118 is depressed downward and fixed to the upper surface of the soft spiral member 20.

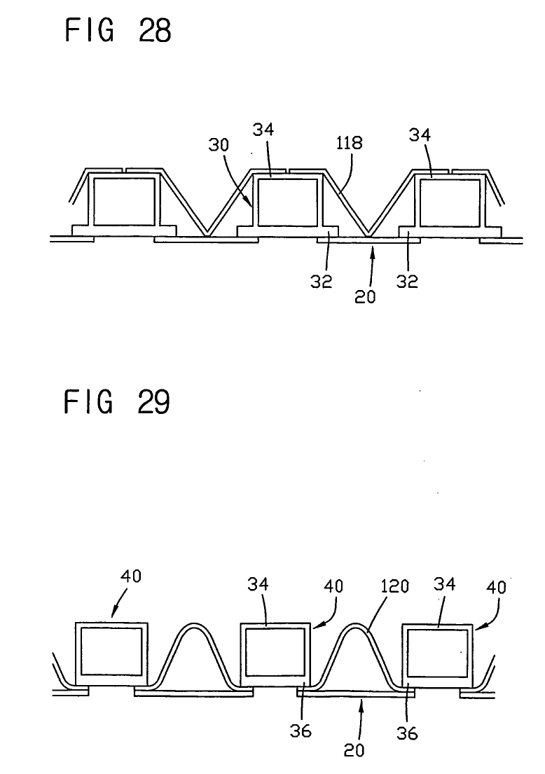

In FIG. 26, the flexure cover 114 is dully curved downward in its transverse sectional view and has a relatively wide central portion attached to the upper surface of the soft spiral member 20. In FIG. 27, the flexure cover 116 is depressed downward while being bent twice with sharp corners in its transverse sectional view, and has a relatively wide central portion attached to the upper surface of the soft spiral member 20. In FIG. 28, the flexure cover 118 is depressed downward while being bent once with a sharp corner in its transverse sectional view, which is a sharp central point attached to the upper surface of the soft spiral member 20.

Embodiment 12

FIGS. 29 to 31 are partial sectional views of spiral hoses according to other embodiments of the present invention, each of which includes a hollow hard spiral member 30, a soft spiral member 20 attached to side edges of a lower surface of the hard spiral member 30, and a reinforcement member assembled between the hard spiral member 30 and the soft spiral member 20.

That is, the flexure cover 120, 122, or 124 is disposed above and along the soft spiral member 20. Side edges of the flexure cover 120, 122, or 124 are attached to side portions of a lower surface of the hard spiral member 30 disposed at either side of the soft spiral member 20, and a central portion of the flexure cover 120, 122, or 124 is curved upward to form a bulging portion.

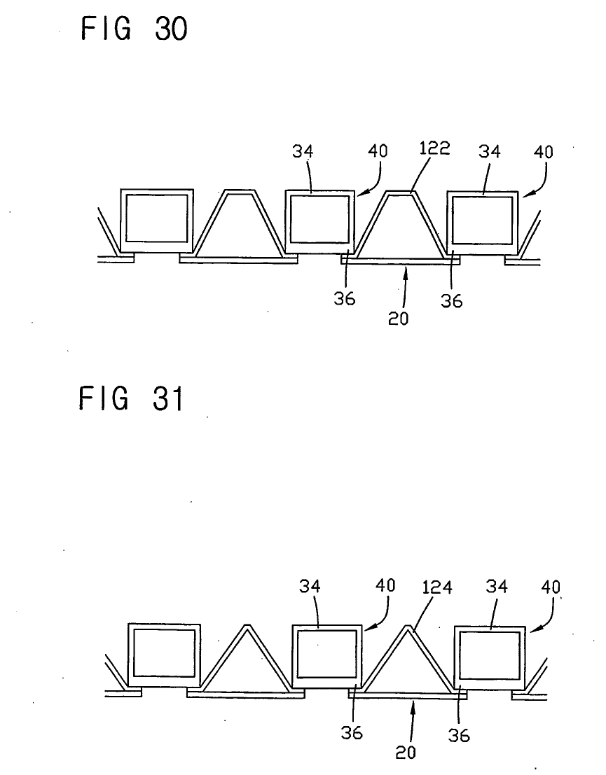

In FIG. 29, the flexure cover 120 has a central bulging portion dully curved upward in its transverse sectional view. In FIG. 30, the flexure cover 122 has a central bulging portion bent twice with sharp corners in its transverse sectional view, which thereby has a relatively wide central portion. In FIG. 31, the flexure cover 124 has a central bulging portion bent once with a sharp corner in its transverse sectional view, which thereby has a sharp central point.

Embodiment 13

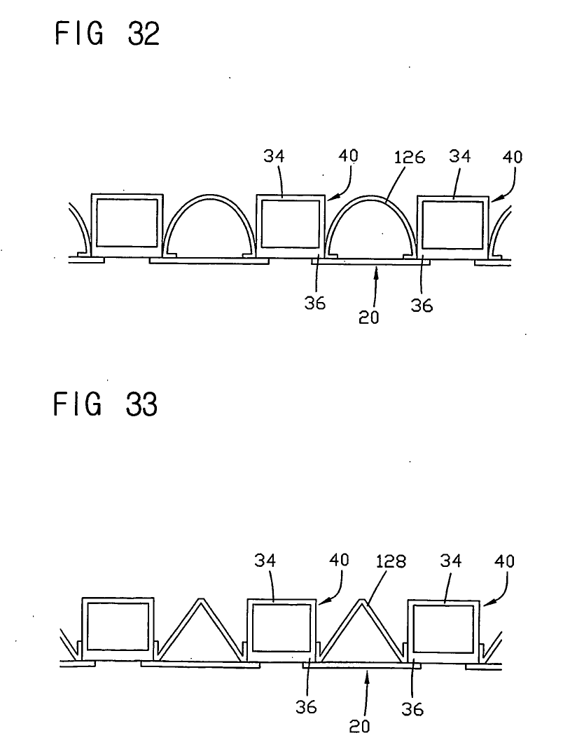

FIGS. 32 and 33 are partial sectional views of spiral hoses according to other embodiments of the present invention, each of which includes a hollow hard spiral member 30 and a soft spiral member 20 assembled together, and a reinforcement member attached to the assembled the hard and soft spiral members 30 and 20. The reinforcement member may be a flexure cover 126 which has a central bulging portion dully curved upward and side edges fixed to side portions of the exposed upper surface of the soft spiral member 20 as shown in its transverse sectional view of FIG. 32, or a flexure cover 128 which has a central upward bulging portion bent once with a sharp corner and side edges fixed to lower portions of the side walls of the hard spiral member 40 as shown in its transverse sectional view of FIG. 33.

Embodiment 14

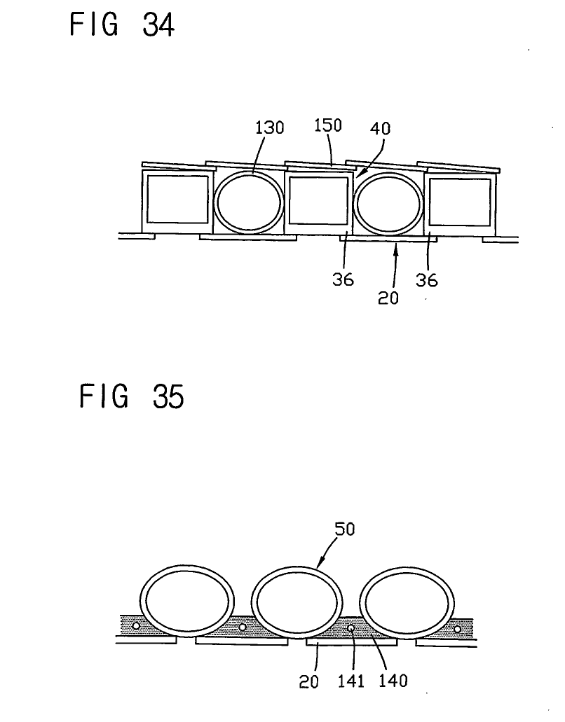

FIG. 34 is a perspective view of a spiral hose utilizing polyethylene according to another embodiment of the present invention, which includes a hollow hard spiral member 30 and a soft spiral member 20 assembled together, and a hollow flexible member 130 which is another type of a reinforcement member.

The hollow flexible member 130 has a flexible member having a hollow shape in its side-sectional view, which is disposed in and along the spiral groove formed on the soft spiral member 20. Outer side portions of the hollow flexible member 130 are attached to adjacent outer side surfaces of the hard spiral member 40. It is preferred that the hollow flexible member 130 is made from soft resin so as to prevent flexibility and bendability of the soft spiral member 20 from deteriorating due to the hollow flexible member 130. Further, not only the outer side portions of the hollow flexible member 130 are attached to adjacent outer side surfaces of the hard spiral member 40, but an outer lower portion of the hollow flexible member 130 may also be attached to an upper surface of the soft spiral member 20, so as to further increase the attachment security of the hollow flexible member 130.

In this construction, the hollow flexible member 130 having the hollow construction elastically maintains the gaps between the turns of the hard spiral member 40, thereby not only improving the strength of the soft spiral member 20 but also enabling the spiral hose to more effectively contract and expand.

In the case where the hollow flexible member 130 is disposed along the spiral gap formed above the soft spiral member 20, alien material may be squeezed between the hollow flexible member 130 and the hard spiral member 40, deteriorating the flexibility of the spiral hose. Therefore, it is preferred that a protection cover 150 is attached on the hollow flexible member 130 to prevent alien material from being introduced into the gap between the hollow flexible member 130 and the hard spiral member 40, thereby preventing the flexibility of the spiral hose from deteriorating due to the introduction of the alien material.

In this case, in order to prevent the flexibility of the spiral hose from being caused to deteriorate by the protection cover 150, the protection cover 150 should be made from soft resin, and the protection cover 150 may employ a single layer structure made from polyethylene tarpaulin or soft polyethylene having a good flexibility or may employ a laminated multi-layer structure made from soft polyethylene/polyethylene tarpaulin. Further, the protection cover 150 may be so wound in a spiral shape as to cover only the hollow flexible member 130 in the spiral groove, or as to cover both the hollow flexible member 130 and the hard spiral member 40. In the latter case, external appearance of the spiral hose can be improved and a tighter assembling force can be provided between the soft and hard spiral members.

Embodiment 15

FIG. 35 is a partial sectional view of a spiral hose according to another embodiment of the present invention, which includes a hollow hard spiral member 50 and a soft spiral member 20 assembled together, and a flexible lamination 140 which is another type of a reinforcement member. The flexible lamination 140 is fixed to an upper surface of the soft spiral member 20 and filled in a spiral groove between turns of the hard spiral member 50.

The flexible lamination 140 tightly attached to the upper surface of the soft spiral member 20 improves the strength of the soft spiral member 20 itself and prevents the soft spiral member 20 from being folded to thereby maintain the uniformity of the gaps between turns of the hard spiral member 50. It is preferred that the flexible lamination 140 is made from soft polyethylene having good flexibility and adhesion.

Especially, the flexible lamination 140 is more useful in the structure shown in FIG. 35, in which the hard spiral member 50 and the soft spiral member 20 are attached to each other while the side surface of the hard spiral member 50 makes an acute angle with respect to the upper surface of the soft spiral member 20, than in the structure in which the side surface of the hard spiral member 50 makes a right angle with respect to the upper surface of the soft spiral member 20, because a wider contact surface can be formed between the flexible lamination 140 and the hard spiral member 50 by the same amount of soft polyethylene to thereby increase adhesion and cohesive force in the former structure than in the latter structure.

Embodiment 16

Further, a hole 141 may be formed through a central portion of each turn of the flexible lamination 140 in its sectional view of FIG. 35, so as to increase the flexibility of the soft spiral member 20. Or, a reinforcement core 142 may be inserted through a hole formed through a central portion of each turn of the flexible lamination 140 in its sectional view of FIG. 36, so as to increase the strength of the soft spiral member 20. These holes 141 or the reinforcement cores 142 may be formed or not according to the use of the spiral hose. Further, when the flexible lamination 140 is made from soft polyethylene, the reinforcement core 142 may preferably be made from high-density polyethylene which is the same material as that of the flexible lamination 140, so as to achieve a stronger cohesive force.

Further, it is preferred that a soft cover 160 having a shape of a band is attached to an upper end of a spiral groove above the flexible lamination 140 to close the inside of the spiral groove, thereby preventing alien material from coming into the spiral groove and thus the flexibility of the spiral hose from deteriorating. In this case, both lateral sides of the soft cover 160 having a band shape may be attached to upper portions of the hard spiral member 10. The soft cover 160 may employ a single layer structure made from polyethylene tarpaulin or soft polyethylene having a good flexibility or may employ a laminated multi-layer structure made from soft polyethylene/polyethylene tarpaulin.

Further, in a spiral hose according to the present invention, when the hard spiral member 50 has a hollow sectional shape, it is more preferable that a reinforcement piece 100 is disposed across the center of the hard spiral member 50 along the entire length of the hard spiral member 50, so as to reinforce the strength of the hard spiral member 50 in its inner and outer directions.

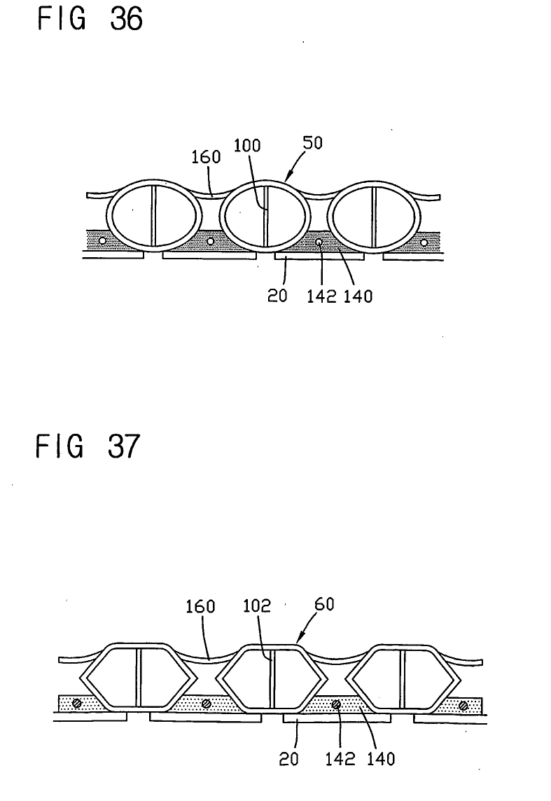

FIG. 37 is a partial sectional view of a spiral hose according to another embodiment of the present invention, which includes a hard spiral member 60 having a hexagonal sectional shape, the soft spiral member 20, the flexible lamination 140, the reinforcement core 142, the soft cover 160, and a reinforcement piece 102, which are assembled together. The function and effect of the spiral hose shown in FIG. 37 are the same as those of the spiral hose shown in FIG. 36.

The following description regarding embodiments 17 to the soft spiral member 20 relates to watering hoses utilizing polyethylene.

Embodiment 17

A watering hose such as that described in embodiment 3 requires various complicated and precise manufacturing steps which include: forming the spray holes 22a, 26a, and 28a through a plurality of polyethylene sheets 22, 26, and 28; and fusing the polyethylene sheets 22, 26, and 28 together with the woven polyethylene fabric layer 24 to each other after aligning the spray holes 22a, 26a, and 28a to each other. Further, when the spray holes 22a, 26a, and 28a are exactly aligned to each other and fusion is performed, a manufactured hose may not function as a spiral hose.

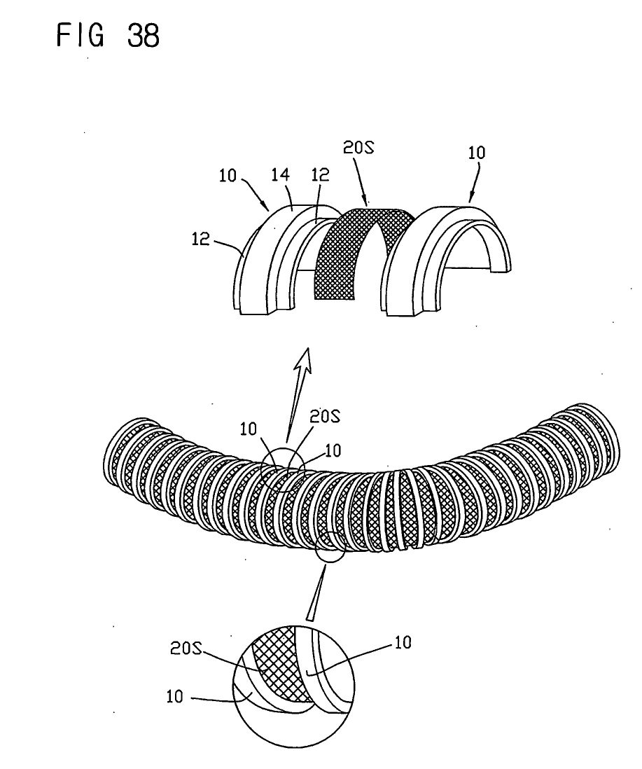

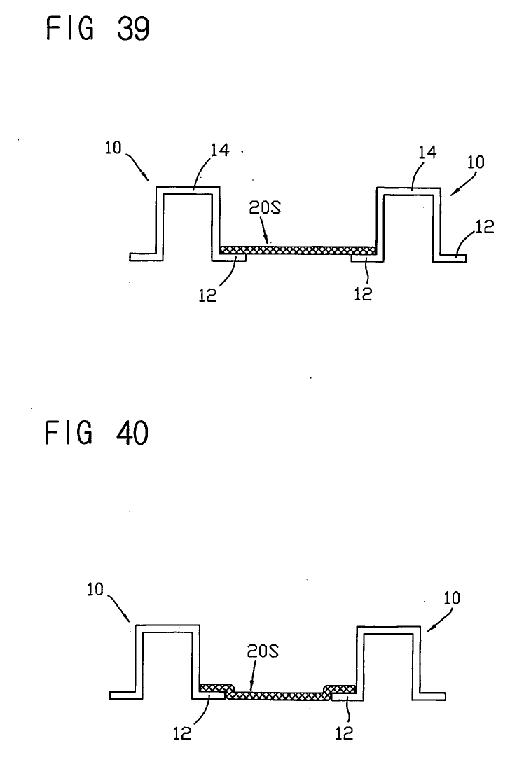

FIG. 38 is a perspective view of a watering hose utilizing polyethylene according to another embodiment of the present invention, and FIG. 39 is a partial sectional view of FIG. 39. As shown, the watering hose includes the hard spiral member 10 and the soft spiral member 20S assembled together.

The hard spiral member 10 is made from polyethylene and extends in a shape of a coil spring with a spiral gap having a uniform width between turns of the coil spring. In its sectional view, the hard spiral member 10 includes the convex section 14 which protrudes upward with angular corners and the flanges 12 which extend laterally from lower ends of the convex section 14.

Further, the soft spiral member 20S has a shape of a band and is made of woven polyethylene fabrics. The soft spiral member 20S is disposed along the spiral gap between turns of the hard spiral member 10, while lateral edges of the soft spiral member 20S are fixed to the flanges 12 disposed oppositely on both sides of the spiral gap. In other words, the hard spiral member 10 and the soft spiral member 20S each extending in a spiral shape are attached to each other in the way described above, thereby forming the watering hose according to the present invention. In this case, it is preferred that the spiral gap between the turns of the hard spiral member 10 has a width of 1.5 to 3.0 cm, so as to prevent the watering hose from being twisted due to the soft spiral member 20S.

In this construction, the hard spiral member 10 made from polyethylene is bent and protrudes outward to form a space inside thereof, so that opposed inner surfaces of the spiral hose are not adhered to each other but the spiral hose can maintain its original shape even when a strong suction pressure is formed in the spiral hose. Further, in the spiral hose, the soft spiral member 20S disposed in the gap between turns of the hard spiral member 10 is made of woven polyethylene fabrics having a high tensile strength and flexibility even with a small thickness, so that the watering hose can sufficiently endure a strong pressure by water, etc., sucked by a pump. Further, the watering hose having the construction described above, in which the soft spiral member 20S is only formed of woven polyethylene fabrics, has a lower production cost and simpler manufacturing process, thereby highly improving the productivity, in comparison with a spiral hose having a soft spiral member made of polyethylene tarpaulin.

Meanwhile, it is preferred that each interval between wefts and between warps of the woven polyethylene fabrics has a wide distance of 5 to 20 mm so that the soft spiral member 20S formed of the woven polyethylene fabrics has a high flexibility along with at least necessary strength.

In a watering hose shown in FIG. 40, lateral edges of the soft spiral member 20S are fixed to the outer surfaces of the flanges 12 of the hard spiral member 10 as are in FIG. 39, while a central portion of the soft spiral member 20S is bent downward so that the lower surface of the soft spiral member 20S is level with the lower surface of the hard spiral member 10. In this case, since the lower surface of the soft spiral member 20S is level with the lower surface of the hard spiral member 10, the pressure of transferred water applied to the soft spiral member 20S can be reduced.

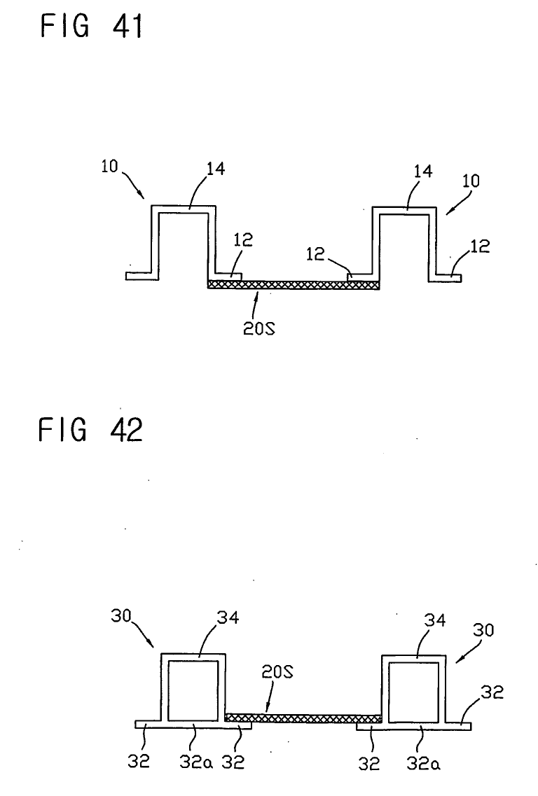

Further, as shown in FIG. 41, side edges of the soft spiral member 20S according to the present invention may be attached to inner surfaces of the flanges 12 of the hard spiral member 10 while the soft spiral member 20S is disposed in the spiral gap between the flanges 12.

Embodiment 18

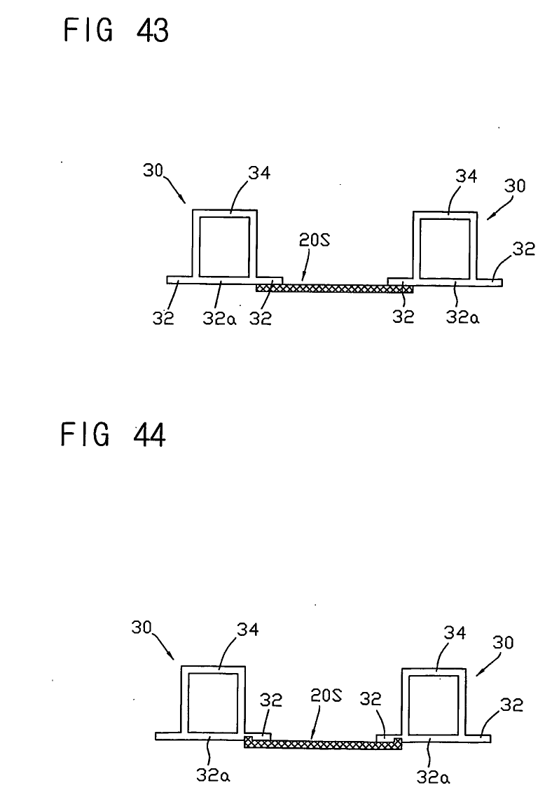

FIGS. 42 and 43 are partial sectional views of watering hoses according to other embodiments of the present invention. As shown, the hard spiral member 30 includes a base section 32a, a convex section 34 which protrudes upward from the base section 32a with angular corners to form a rectangular space therein, and flanges 32 which extend laterally from the base section 32a. In this case, both side edges of the soft spiral member 20S may be attached to either inner surfaces or outer surfaces of the flanges 32.

This construction enables the hard spiral member 30 to have a closed space therein, thereby enabling the watering hose to more firmly keep its shape.

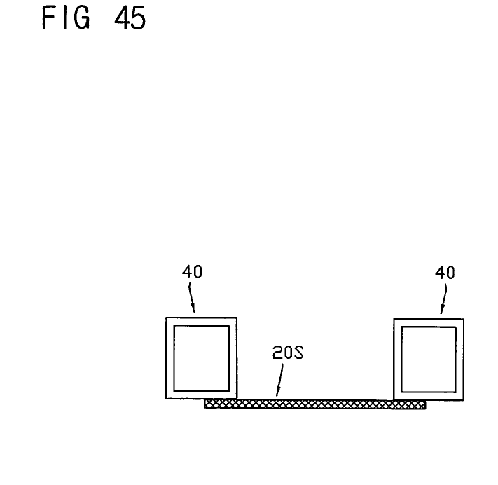

FIG. 44 is a sectional view showing another assembly between the hard spiral member 30 and the soft spiral member 20S according to another embodiment of the present invention, in which grooves are formed longitudinally along side portions of the lower surface of the hard spiral member 30 and side edges of the soft spiral member 20S are inserted in the grooves, so that the side ends of the soft spiral member 20S are then sealed to be watertight and the hard spiral member 30 and the soft spiral member 20S can be more firmly assembled together.

Embodiment 19

FIG. 45 is a partial sectional view of a watering hose utilizing polyethylene according to another embodiment of the present invention, in which the hard spiral member 40 has a hollow polygonal section without the flanges and side edges of the soft spiral member 20S made from woven polyethylene fabrics may be attached to side portions of the lower surfaces of the hard spiral member 40.

Embodiment 20

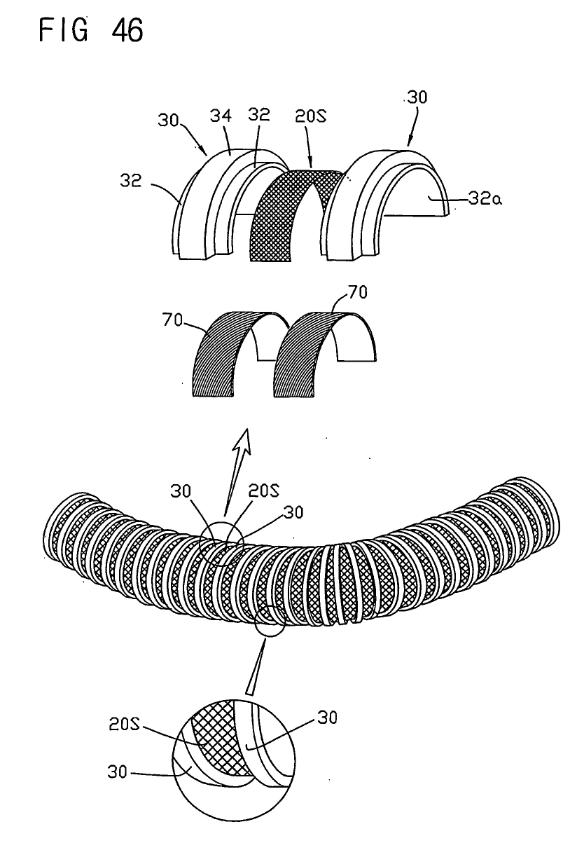

FIG. 46 is a perspective view of a watering hose utilizing polyethylene according to another embodiment of the present invention, and FIG. 47 is a partial sectional view of the watering hose shown in FIG. 46. As shown, the watering hose according to the present embodiment includes not only the hard spiral member 30 and the soft spiral member 20S attached together but also the fastening band 70 having a shape of a band made from soft polyethylene.

That is, the fastening band 70 having a shape of a band made from soft polyethylene is attached to an exposed portion of a lower surface of the base section 32a and side portions of the soft spiral member 20S disposed at both sides of the exposed portion. Reference numerals not described in this embodiment designate the same elements as those in the embodiment shown in FIG. 43.

In this construction, since a central portion of the fastening band 70 made from soft polyethylene film is tightly attached to the exposed portion of the lower surface of the base section 32a and side portions of the fastening band 70 are tightly attached to the side portions of the soft spiral member 20S disposed at both sides of the exposed portion, the attachment portions between the soft spiral member 20S and the hard spiral member 30 are compressed so as to largely improve the durability of the watering hose.

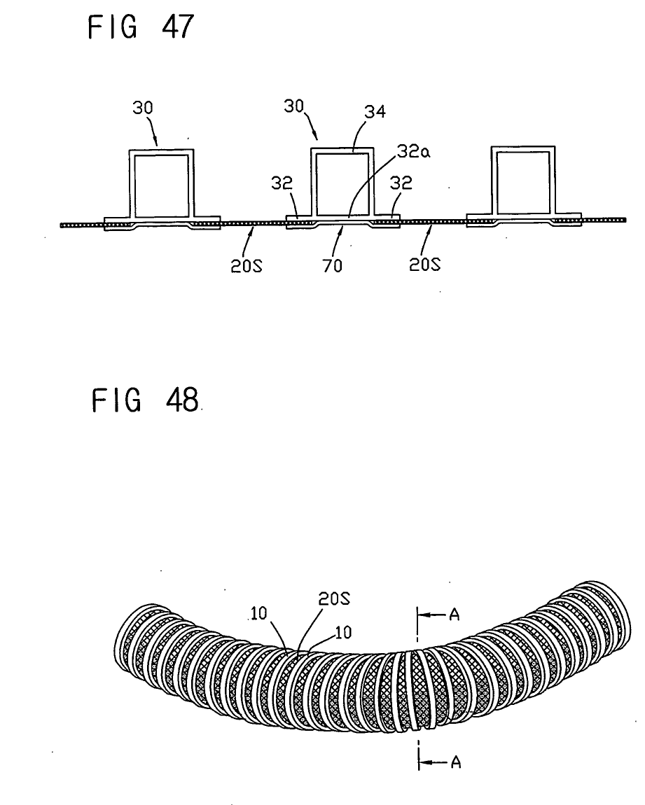

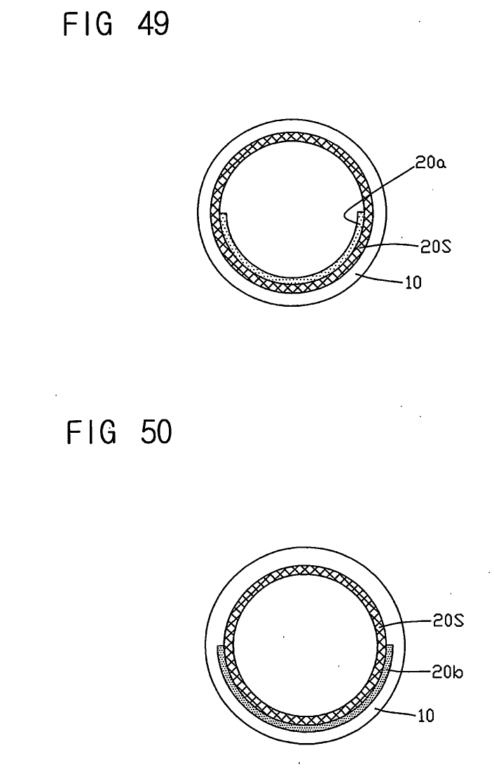

FIG. 48 is a perspective view of a watering hose according to another embodiment of the present invention, and FIG. 49 is a sectional view taken along line A-A in FIG. 48. As shown, the watering hose according to the present embodiment further includes a coated film 20c formed on a lower portion of the inner surface of the watering hose having the construction shown in FIG. 38. That is, the coated film 20c is formed on the lower portion of the inner surface of the watering hose having the hard spiral member 10 and the soft spiral member 20S, so as to block gaps formed through a lower portion of the woven polyethylene fabrics from among the soft spiral member 20S.

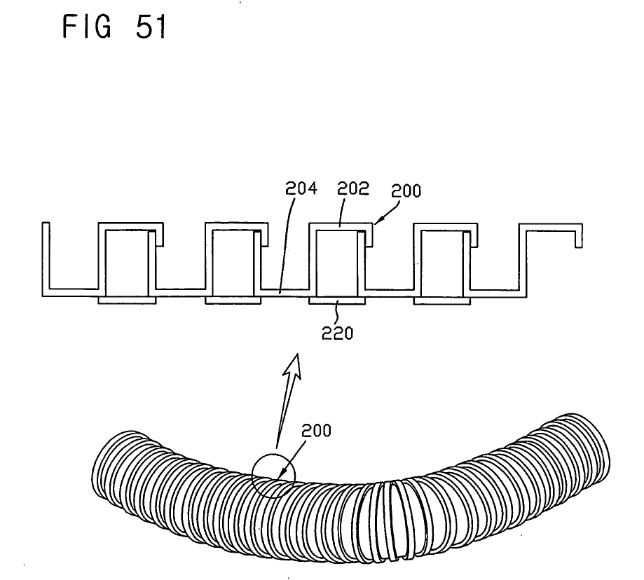

In this construction, fluid is prevented from being discharged through the lower gaps through a lower portion of the spiral hose, so that fluid having been introduced through upper gaps of the spiral hose can be safely carried up to a desired destination. Further, a coated film 20b may be interposed between the hard spiral member 10 and the soft spiral member 20S as shown in FIG. 50.

It is preferred that the coated films 20b and 20c are made from low-density polyethylene having a good flexibility, since they need not endure pressure of the fluid but have only a function of blocking the gaps through the woven polyethylene fabrics.

In addition to the various spiral hoses utilizing polyethylene according to various embodiments of the present invention as described above, the following embodiments 21 and 22 show other several spiral hoses having spiral flexure portions, which have attachment portions with increased attachment force and can be manufactured by a simplified process, thereby improving productivity.

Embodiment 21

In the spiral hoses utilizing polyethylene as described above, soft and hard spiral members are attached to each other by heat fusion while extending in a spiral shape, respectively. Therefore, the manufacturing process of the spiral hose is very complicated and difficult, so that the productivity is deteriorated. Further, when the hose severely shakes, the heat-fused attachment portion between the two members having different properties may be easily separated from each other.

FIG. 51 is a perspective view of a spiral hose utilizing polyethylene according to another embodiment of the present invention. As shown, the spiral hose is formed of a single polyethylene member 200.

That is, the polyethylene member 200 is a member having a shape of a band which is bent to form a convex portion 202 and a concave portion 204 adjacent to each other in its sectional view. The polyethylene member 200 having this construction is wound in a coil shape to form the spiral hose. In this case, a plurality of the convex portions 202 and a plurality of the concave portions 204 are alternately engaged with and fused to each other, so as to form an integral spiral hose.

In the spiral hose having the construction described above, since the spiral hose is formed of the single band-shaped polyethylene member, the manufacturing process of the spiral hose can be simplified to highly improve the productivity. Further, the heat-fused portions are made from the same single material and thereby have a strong cohesive force, so that they are prevented from being separated from each other even when the spiral hose severely shakes.

It is preferred that the polyethylene member 200 is made from high-density polyethylene having a density of about 0.941 to 0.965 g/cm². The high-density polyethylene has a tensile strength of only 330 to 340 kg/cm², which is 2.5 times larger than that of the low-density polyethylene, thereby having nearly the same breaking point as that of the woven polyethylene fabrics, enough to endure the pressure of transferred water when the high-density polyethylene layer 28 has been coated on the woven polyethylene fabric layer 24.

In an enlarged view in FIG. 51, the polyethylene member 200 has a shape like a laid “S” in its side sectional view, so that the convex portion 202 and the concave portion 204 can be assembled together to form a rectangular sectional shape.

Further, in the polyethylene member 200, side edges of a reinforcement band 220 may be attached to lower side ends of the concave portion 204 disposed at either side of the convex portion 202 so as to form a closed space inside of the convex portion 202.

In this construction, a continuous spiral space is formed inside of the spiral hose, so that the spiral hose can have an improved strength and the reinforcement band 220 can uniformly maintain the gap between the lower ends of the convex portion 202, thereby preventing the spiral hose from being deformed and improving the durability of the spiral hose.

Embodiment 22

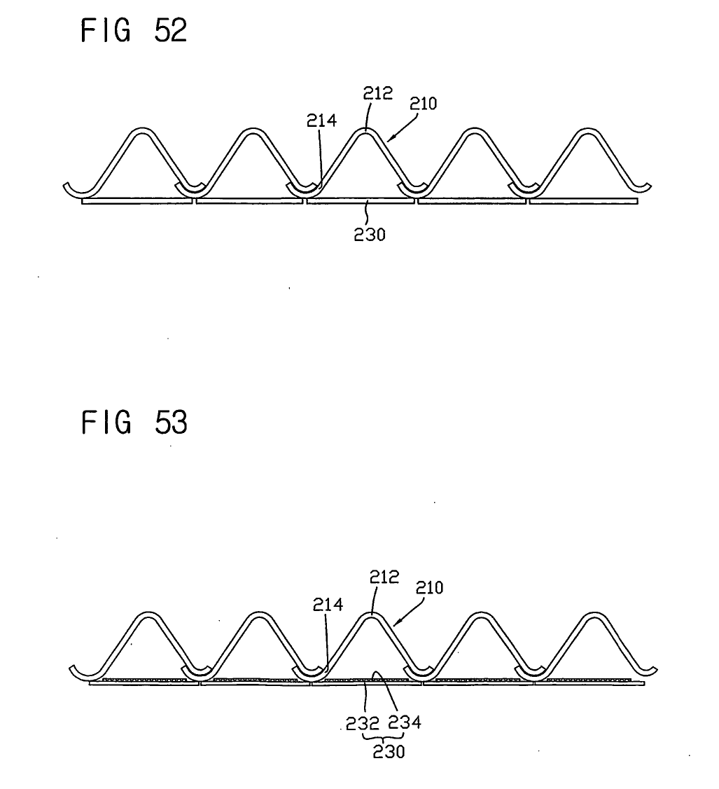

FIG. 52 is an enlarged partial sectional view of a spiral hose utilizing polyethylene according to another embodiment of the present invention.

As shown, a polyethylene member 210 according to the present invention includes a convex portion 212 and a concave portion 214 integrated with each other to form a shape like a sine wave in its sectional view. In this case, the polyethylene member 210 is wound in a coil shape, and end portions of the convex portion 212 and the concave portion 214 in contact with each other are then overlapped and heat-fused, so as to form the integral spiral hose.

Further, in the construction described above also, it is preferred that side ends of a reinforcement band 230 are continuously heat-fused to the lower end portions of the concave portion 214, to thereby increase the strength of the spiral hose, prevent the spiral hose from being deformed, and improve the durability of the spiral hose.

Meanwhile, the reinforcement band 220 and 230 may be made from polyethylene tarpaulin, soft polyethylene, or silicon. Polyethylene tarpaulin has a high tensile strength so as to highly increase the durability of the spiral hose. Soft polyethylene has a high flexibility to thereby enable ripple portions of two spiral hoses to be easily assembled with each other. Silicon, especially, not only has a high flexibility to thereby enable ripple portions of two spiral hoses to be easily assembled with each other, but also has a high surface smoothness to thereby reduce frictional resistance and a high melting point to thereby have a high thermal durability.

FIG. 53 is an enlarged partial sectional view of a spiral hose utilizing polyethylene according to another embodiment of the present invention, which includes a reinforcement band 230 formed of a soft polyethylene layer 232 and a polyethylene tarpaulin layer 234.

That is, the soft polyethylene layer 232 has a shape of a band extending with a uniform width, and the polyethylene tarpaulin layer 234 has a width smaller than that of the soft polyethylene layer 232. Therefore, the polyethylene tarpaulin layer 234 with a relatively smaller width is attached along a central portion of the soft polyethylene layer 232 in its transverse direction, so that edge portions of the soft polyethylene layer 232 in its transverse direction are exposed. Further, the exposed edge portions of the soft polyethylene layer 232 to which the polyethylene tarpaulin layer 234 is attached are continuously heat-fused to the lower surface of the concave portion 214 at either side of the convex portion 212.

In this construction, the exposed edge portions of the soft polyethylene layer 232 continuously heat-fused to the lower surface of the concave portion 214 at either side of the convex portion 212 form a continuous closed space inside of the convex portion 212, and the soft polyethylene layer 232 is strongly held by the polyethylene tarpaulin layer 234, so that the durability of the spiral hose can be highly improved.

In the construction as shown in FIG. 53, instead of the soft polyethylene layer 232, soft resin such as silicon may be utilized. Especially, the silicon has a high flexibility, a high surface smoothness, and a high melting point and thermal durability, to thereby enable ripple portions of two spiral hoses to be easily assembled with each other, to thereby reduce frictional resistance thereby minimizing shaking of the spiral hose even when fluid is carried with a high pressure, and to thereby prevent thermal deformation of the spiral hose.

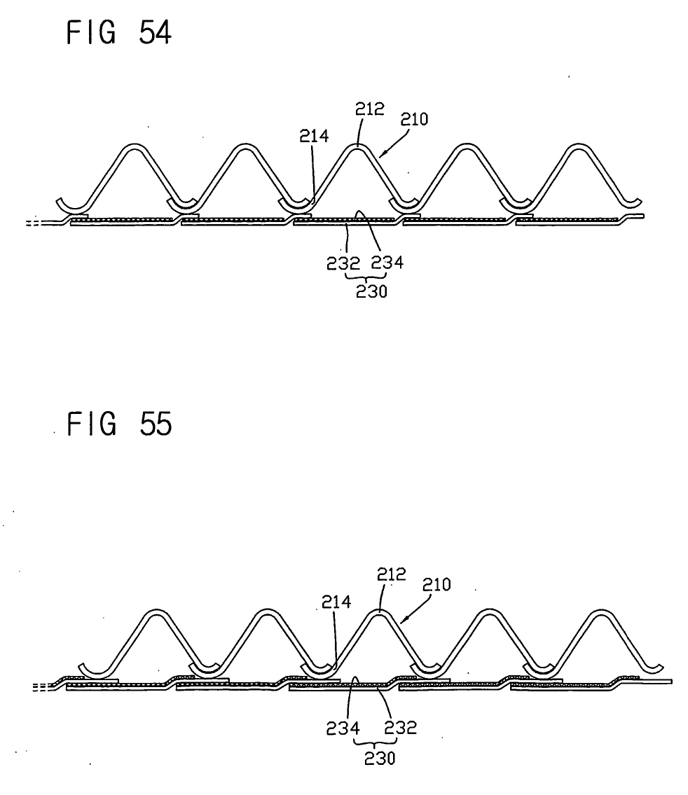

FIG. 54 is an enlarged partial sectional view of a spiral hose utilizing polyethylene according to another embodiment of the present invention, which includes a reinforcement band 230 formed of a polyethylene tarpaulin layer 234 and a soft polyethylene layer 232.

That is, the soft polyethylene layer 232 has a shape of a band extending with a uniform width, and the polyethylene tarpaulin layer 234 has a width smaller than that of the soft polyethylene layer 232. Therefore, the polyethylene tarpaulin layer 234 with a relatively smaller width is attached along a side portion of the soft polyethylene layer 232 in its transverse direction, so that the other side portion of the soft polyethylene layer 232 in its transverse direction is exposed. In other words, the soft polyethylene layer 232 has an exposed and a covered side portion which are opposite to each other in the transverse direction of the soft polyethylene layer 232. In this case, the covered side portion signifies a transverse side portion covered by the polyethylene tarpaulin layer 234, and the exposed side portion signifies the other transverse side portion not covered by the polyethylene tarpaulin layer 234.

Further, at one side of the convex portion 212, the exposed side portion of the soft polyethylene layer 232 is attached to the lower surface of the concave portion 214, and the covered side portion of the soft polyethylene layer 232 is then attached to the lower surface of the exposed side portion of the soft polyethylene layer 232 attached to the lower surface of the concave portion 214.

By this construction, the spiral hose has advantages owing to the attachment between soft polyethylene and polyethylene tarpaulin as described in relation to the embodiment shown in FIG. 53. Moreover, the spiral hose can have a further improved durability by the reinforcement band 230 continuously formed on the lower surface of the concave portion 214, which has the three-layer construction of the soft polyethylene layer 232, the polyethylene tarpaulin layer 234, and the soft polyethylene layer 232 in sequence.

FIG. 55 is an enlarged partial sectional view of a spiral hose utilizing polyethylene according to another embodiment of the present invention.

In the shown spiral hose, a soft polyethylene layer 232 and a polyethylene tarpaulin layer 234 are laminated onto each other in such a way that the reinforcement band 230 has an exposed and a covered side portion which are opposite to each other in the transverse direction of the reinforcement band 230. At one side of the convex portion 212, the covered side portion of the reinforcement band 230 not only overlaps the exposed side portion of the reinforcement band 230 but also partially overlaps the covered side portion beyond the exposed side portion of the reinforcement band 230, so that the lamination attached to the lower surface of the concave portion 214 includes two layers of the covered side portions.

This construction enables the polyethylene tarpaulin layer 234 having a relatively large tensile strength to have a continuous construction without a severance, which increases the tensile strength of the reinforcement band 230, thereby improving the durability of the spiral hose.

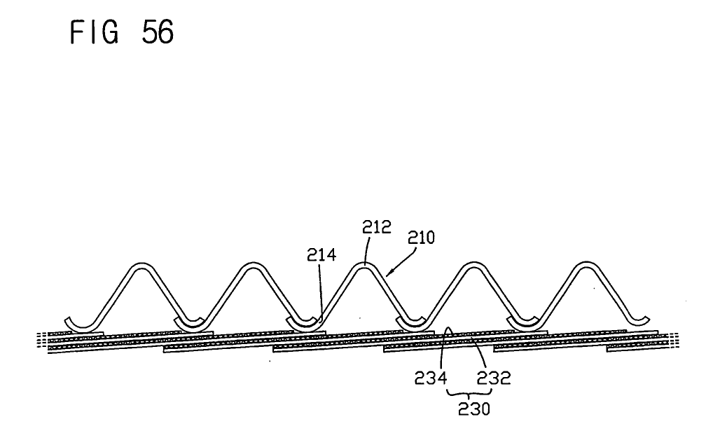

FIG. 56 is an enlarged partial sectional view of a spiral hose utilizing polyethylene according to another embodiment of the present invention, in which the covered side portion of the reinforcement band 230 extends in its transverse direction longer than that shown in FIG. 55, that is, from the lower surface of the concave portion 214 at one side of the convex portion 212 beyond the lower surface of the concave portion 214 at the other side of the convex portion 212, so that the lamination attached to the lower surface of the concave portion 214 includes three layers of covered side portions of the reinforcement band 230 consisting of a soft polyethylene layer 232 and a polyethylene tarpaulin layer 234. This construction increases the cohesion between the side portions of the reinforcement band 230 to thereby highly improve the durability of the spiral hose. Further, the covered portion of the reinforcement band 230 may further extend to form a lamination attached to the lower surface of the concave portion 214, which includes at least four layers of covered side portions of the reinforcement band 230.

Even in the constructions shown in FIGS. 54 to 56, soft resin such as silicon may be employed instead of the soft polyethylene layer 232. Silicon can enable ripple portions of two spiral hoses to be easily assembled with each other, reduce frictional resistance thereby minimizing shaking of the spiral hose even when fluid is carried with a high pressure, and prevent thermal deformation of the spiral hose. In this case, it goes without saying that the constructions as shown in FIGS. 53 to 56 may be employed and may have the same effect as those and may have the same effect as those in the reinforcement band 220 shown in FIG. 51.

### INDUSTRIAL APPLICABILITY

As can be seen from the foregoing, in a spiral hose according to the present invention, a hard member made from polyethylene has a sectional shape protruding outward with angular corners and extends in a spiral shape, and a soft member made from polyethylene tarpaulin with a small thickness is attached to the hard member while extending along a spiral gap formed between each turns of the spiral hard member. By this construction, the spiral hose has not only a sufficient resistance to internal pressure owing to the hard polyethylene member but also a high tensile strength and excellent flexibility owing to the soft member made from polyethylene tarpaulin. Therefore, in comparison with a PVC hose, a spiral hose having the same resistance to pressure can be manufactured at a lower cost and has smaller weight which enables the spiral hose to be easily carried and installed.

Further, in the case where the coated polyethylene tarpaulin layer forming the soft member has a plurality of spray holes, the spiral hose may be utilized as a watering hose. Moreover, in the case where each interval between wefts and between warps of a woven polyethylene fabric layer has a wide distance of 5 to 20 mm, the spiral hose has a further improved flexibility so that the spiral hose can be employed as a gas duct which can be bent more than 90° when the duct is installed.

Further, the spiral hose according to the present invention may include a fastening band attached along the joint portion between the hard and soft members of the spiral hose. As a result, the spiral hose not only can have a higher tensile strength and flexibility while being lighter than a PVC hose, but also side ends of the soft member need not be subjected to watertight coating, thereby increasing cohesion between the hard and soft members. Moreover, the cohesion between the hard and soft members can be increased to thereby highly increase the durability of the spiral hose.

Also, in the spiral hose utilizing polyethylene according to the present invention, a hard spiral member and a soft spiral member are assembled with each other while extending in a spiral shape, respectively, to enable the spiral hose to have a higher tensile strength, flexibility, strong resistance to internal pressure. The thick hard member has an adiabatic characteristic through its own quality of thickness, and the thin soft member has an adiabatic characteristic through being covered with a foam and an aluminum foil. Therefore, the spiral hose can insulate heat without a separate cover, thereby having an excellent heat-keeping effect. Further, the spiral hose can be easily installed and used and can maintain the heat-insulation characteristic even when it has been used for long time. In other words, the spiral hose is economical and keeps a clean appearance, thereby improving the marketability of the spiral hose.

Also, in the spiral hose utilizing polyethylene according to the present invention, which includes a hard spiral member and a soft spiral member assembled with each other while extending in a spiral shape, a reinforcement member may be disposed along a spiral groove above the soft spiral member while connecting turns of the hard spiral member with each other, so as to reinforce the strength of the soft spiral member and uniformly maintain the spiral gap between the turns of the hard spiral member. As a result, the spiral hose can be prevented from being expanded and contracted, and the durability and marketability of the spiral hose can be highly improved.

Moreover, the spiral hose according to the present invention may further include a reinforcement piece disposed across the hollow space of the hard spiral member, which prevents the hard spiral member from being deformed by external force and prevents the strength and the draining function of the spiral hose from being deteriorated due to the possible deformation of the hard spiral member.

Also, the present invention provides a watering hose utilizing polyethylene according to the present invention, in which a hard member made from polyethylene extends in a spiral shape with a spiral gap between turns of the hard member, and a soft member made from woven polyethylene fabrics is attached to the hard member while extending along the spiral gap. This construction enables the watering hose to have not only a sufficient resistance to internal pressure owing to the hard polyethylene member but also a high tensile strength and excellent flexibility owing to the soft member made from polyethylene tarpaulin. Therefore, in comparison with a PVC hose, the watering hose having the same resistance-to-pressure can be manufactured at a lower cost and has smaller weight which enables the watering hose to be easily carried and installed.

Further, the watering hose according to the present invention may include a soft polyethylene film having a band shape, which is attached along the joint portion between the hard and soft members of the spiral hose. As a result, the cohesion between the hard and soft members can be increased to thereby highly increase the durability of the watering hose.

Furthermore, the spiral hose according to the present invention may be formed of a single polyethylene member. In this case, the manufacturing process of the spiral hose can be simplified to thereby increase the productivity, and the joint portions of the single polyethylene member can have a stronger cohesion to thereby improve the durability of the spiral hose.

In addition, the spiral hose according to the present invention may include a reinforcement band for attaching adjacent concave portions to each other, thereby increasing the strength of the spiral hose, preventing deformation of the spiral hose, and highly improving the durability of the spiral hose.

While this invention has been described in connection with what are presently considered to be the most practical and preferred embodiments, it is to be understood that the invention is not limited to the disclosed embodiment and the drawings, but, on the contrary, it is intended to cover various modifications and variations within the spirit and scope of the appended claims.

1. A spiral hose utilizing polyethylene wound in a spiral shape to have flexibility, the spiral hose comprising:
a hard member made from polyethylene, which is wound in a spiral shape with a uniform spiral gap formed between turns of the hard member; and
a soft member having a shape of a band and being formed of polyethylene tarpaulin, the soft member being disposed along the spiral gap while lateral edges of the soft member are fixed to portions of the hard member, which are disposed oppositely on both sides of the spiral gap.

2. A spiral hose utilizing polyethylene according to claim 1, wherein the hard member comprises a convex section protruding upward with angular corners and flanges extending laterally from lower ends of the convex section, and the lateral edges of the soft spiral member are attached to the flanges disposed oppositely on both sides of the spiral gap.

3. A spiral hose utilizing polyethylene according to claim 2, wherein the hard spiral member assembled with the soft member is bent and protrudes outward, and the flanges are integrally connected with each other, so as to form a space inside of the hard member.

4. A spiral hose utilizing polyethylene according to claim 1, wherein the soft member comprises a woven polyethylene fabric layer and at least one polyethylene coating layer coated on the woven polyethylene fabric layer, the polyethylene coating layer having a plurality of spray holes, so that the spiral hose can be used as a watering hose.

5. A spiral hose utilizing polyethylene according to claim 1, wherein the soft member comprises a woven polyethylene fabric layer, each interval between wefts and between warps of the woven polyethylene fabric layer having a wide distance of 5 to 20 mm.

6. A spiral hose utilizing polyethylene according to one of claims 1 to 5, wherein the soft member is formed of polyethylene tarpaulin which includes a woven polyethylene fabric layer and at least one polyethylene coating layer coated on at least one surface of the woven polyethylene fabric layer.

7. A spiral hose utilizing polyethylene according to one of claims 1 to 5, wherein the soft member is formed of polyethylene tarpaulin, which includes a woven polyethylene fabric layer and low-density and high-density polyethylene coating layers coated in sequence on at least one surface of the woven polyethylene fabric layer.

8. A spiral hose utilizing polyethylene according to one of claims 1 to 5, wherein the soft member is formed of polyethylene tarpaulin, both side edges of which are fixed to outer surfaces of the flanges of the hard member, respectively.

9. A spiral hose utilizing polyethylene according to one of claims 1 to 5, wherein the soft member is formed of polyethylene tarpaulin, both side edges of which are fixed to inner surfaces of the flanges of the hard member, respectively.

10. A spiral hose utilizing polyethylene according to claim 1, wherein side ends of the polyethylene tarpaulin forming the soft spiral member are coated to form watertight ends.

11. A spiral hose utilizing polyethylene according to claim 1, the spiral hose further comprising a fastening band attached along a joint portion between the hard member and the soft member.

12. A spiral hose utilizing polyethylene according to claim 1, the spiral hose further comprising a heat-insulation foam fixed in a spiral gap formed between turns of the hard member and on the soft member.

13. A spiral hose utilizing polyethylene according to claim 12, wherein the hard member is made from high-density polyethylene, the soft member is formed of polyethylene tarpaulin, and the heat-insulation foam is formed of polyethylene foam.

14. A spiral hose utilizing polyethylene according to claim 12 or 13, the spiral hose further comprising an aluminum foil attached to an upper surface of the heat-insulation foam.

15. A spiral hose utilizing polyethylene according to claim 12 or 13, the spiral hose further comprising an aluminum foil attached to an outer surface of the spiral hose, the hard member and the heat-insulation foam forming the outer surface of the spiral hose, the aluminum foil being wound around the outer surface of the spiral hose in a spiral shape, thereby forming an outermost layer of the spiral hose.

16. A spiral hose utilizing polyethylene according to claim 12 or 13, the spiral hose further comprising aluminum foils attached in sequence to one surface of the soft member.

17. A spiral hose utilizing polyethylene according to claim 12 or 13, the spiral hose further comprising an aluminum foil attached to a lower surface of the heat-insulation foam, the aluminum foil having a shape of a band.

18. A spiral hose utilizing polyethylene according to claim 1, the spiral hose further comprising a reinforcement member made from soft material and fixed on the soft member, the reinforcement member having transverse side ends fixed to both sides of the hard member, thereby maintaining a uniform between turns of the hard member.

19. A spiral hose utilizing polyethylene according to claim 18, wherein the hard member and reinforcement member are made from polyethylene, and the soft member is made from at least one of polyethylene tarpaulin and soft polyethylene.

20. A spiral hose utilizing polyethylene according to claim 18 or 19, wherein the reinforcement member is a flexure cover which has side edges attached to adjacent side portions of an upper surface of the hard spiral member and a central portion being concave downward in a transverse sectional view of the flexure cover.

21. A spiral hose utilizing polyethylene according to claim 20, wherein the central portion of the flexure cover concave downward is fixed to an upper surface of the soft member disposed under the flexure cover.

22. A spiral hose utilizing polyethylene according to claim 18 or 19, wherein the reinforcement member is a flexure cover which has side edges and a central portion, the side edges being fixed between side edges of the soft member and side portions of a lower surface of the hard member, the central portion being concave upward in a transverse sectional view of the flexure cover.

23. A spiral hose utilizing polyethylene according to claim 18 or 19, wherein the reinforcement member is a flexure cover which has side edges and a central portion, the side edges being fixed onto an exposed surface of the soft member, the central portion being concave upward in a transverse sectional view of the flexure cover.

24. A spiral hose utilizing polyethylene according to claim 18 or 19, wherein the reinforcement member is a flexure cover which has side edges and a central portion, the side edges being fixed to lower portions of side surfaces of the hard member, which are disposed both side of the soft member at each turn of the hard member, the central portion being concave upward in a transverse sectional view of the flexure cover.

25. A spiral hose utilizing polyethylene according to claim 18 or 19, wherein the reinforcement member is a hollow flexible member fixed in the spiral gap formed on the soft member, the hollow flexible member having outer side portions attached to adjacent outer side surfaces of the hard member.

26. A spiral hose utilizing polyethylene according to claim 25, the spiral hose further comprising a protection cover attached on the hollow flexible member, the protection cover having flexibility and forming the outer surface of the spiral hose.

27. A spiral hose utilizing polyethylene according to claim 26, wherein the protection cover is made from at least one of polyethylene tarpaulin and soft polyethylene.

28. A spiral hose utilizing polyethylene according to claim 18 or 19, wherein the hard member has a hollow sectional shape; and the reinforcement member is a flexible lamination fixed to an upper surface of the soft member and filled in a lower portion of the spiral gap between turns of the hard spiral member.

29. A spiral hose utilizing polyethylene according to claim 28, wherein the flexible lamination has a plurality of holes, each of which is formed through a central portion of each turn of the flexible lamination in a sectional view of the flexible lamination.

30. A spiral hose utilizing polyethylene according to claim 29, the spiral hose further comprising a plurality of reinforcement cores inserted in said holes formed through the central portion of each turn of the flexible lamination.

31. A spiral hose utilizing polyethylene according to claim 30, wherein the flexible lamination is made from soft polyethylene, and the reinforcement cores are made from high-density polyethylene.

32. A spiral hose utilizing polyethylene according to claim 28, the spiral hose further comprising a soft cover having a band shape, the soft cover having lateral sides attached to upper portions of the hard member at both sides of the spiral gap.

33. A spiral hose utilizing polyethylene according to claim 28, the spiral hose further comprising a reinforcement piece disposed across a center of a hollow space in the hard member.

34. A watering hose utilizing polyethylene wound in a spiral shape to have flexibility, the watering hose comprising:
a hard member made from polyethylene, which is wound in a spiral shape with a uniform spiral gap formed between turns of the hard member; and
a soft member having a shape of a band and being formed of polyethylene tarpaulin, the soft member being disposed along the spiral gap while lateral edges of the soft member are fixed to portions of the hard member, which are disposed oppositely on both sides of the spiral gap.

35. A watering hose utilizing polyethylene according to claim 34, wherein the hard member comprises a convex section protruding upward with angular corners and flanges extending laterally from lower ends of the convex section, and the lateral edges of the soft spiral member are attached to the flanges disposed oppositely on both sides of the spiral gap.

36. A watering hose utilizing polyethylene according to claim 35, wherein the hard spiral member assembled with the soft member is bent and protrudes outward, and the flanges are integrally connected with each other, so as to form a base section which defines a closed space inside of the hard member.

37. A watering hose utilizing polyethylene according to claim 34, wherein the soft member comprises a woven polyethylene fabric layer, each interval between wefts and between warps of the woven polyethylene fabric layer having a wide distance of 5 to 20 mm.

38. A watering hose utilizing polyethylene according to one of claims 34 to 37, wherein the soft member has side edges fixed to outer surfaces of the flanges of the hard member.

39. A watering hose utilizing polyethylene according to one of claims 34 to 37, wherein the soft member has side edges fixed to inner surfaces of the flanges of the hard member.

40. A watering hose utilizing polyethylene according to claim 39, the watering hose further comprising a soft polyethylene film having a band shape, the soft polyethylene film being attached to an exposed portion of a lower surface of the base section and side portions of the soft member disposed at both sides of the exposed portion.

41. A watering hose utilizing polyethylene according to claim 34, the watering hose further comprising a coated film formed on a lower portion of the inner surface of the watering hose, so as to block gaps formed through a lower portion of a woven polyethylene fabric layer of the soft member.

42. A watering hose utilizing polyethylene according to claim 34, the watering hose further comprising a coated film formed between the hard member and the soft member, so as to block gaps formed through a lower portion of a woven polyethylene fabric layer of the soft member.

43. A spiral hose utilizing polyethylene, which includes a polyethylene member having a band shape, the polyethylene member comprising a convex portion and a concave portion adjacent to each other in a transverse sectional view of the polyethylene member, the polyethylene member being wound in a spiral shape while a plurality of the convex portions and a plurality of the concave portions are alternately engaged with and fused to each other, so as to form an integral spiral hose.

44. A spiral hose utilizing polyethylene according to claim 43, wherein each of the convex portions and concave portions has a rectangular shape in a transverse sectional view of the polyethylene member.

45. A spiral hose utilizing polyethylene according to claim 43, wherein the convex portion and the concave portion integrated with each other form a shape like a sine wave in a transverse sectional view of the polyethylene member.

46. A spiral hose utilizing polyethylene according to one of claims 43 to 45, the spiral hose further comprising a reinforcement band attached to at least two lower side ends of the concave portion disposed at either side of the convex portion so as to form a closed space inside of the convex portion.

47. A spiral hose utilizing polyethylene according to claim 46, wherein the reinforcement band is made from at least one of polyethylene tarpaulin and soft polyethylene.

48. A spiral hose utilizing polyethylene according to claim 46, wherein the reinforcement band is formed of a soft polyethylene layer and a polyethylene tarpaulin layer, the polyethylene tarpaulin layer having a width smaller than that of the soft polyethylene layer, the polyethylene tarpaulin layer being attached along a central portion of the soft polyethylene layer in a transverse view of the soft polyethylene layer so that edge portions of the soft polyethylene layer are exposed.

49. A spiral hose utilizing polyethylene according to claim 46, wherein the reinforcement band is formed of a soft polyethylene layer and a polyethylene tarpaulin layer, the polyethylene tarpaulin layer having a width smaller than that of the soft polyethylene layer, the polyethylene tarpaulin layer being attached to an upper surface of a first side portion of the soft polyethylene layer in a transverse view of the soft polyethylene layer so that a second side portion of the soft polyethylene layer are exposed, the second side portion being attached to a lower surface of the first side portion in a transverse view of the soft polyethylene layer.

50. A spiral hose utilizing polyethylene according to claim 49, wherein the second side portion is attached to the lower surface of the first side portion of the soft polyethylene layer while covering at least one adjacent concave portion, so that turns of the soft polyethylene layer overlapping on each other at each concave portion of the soft polyethylene layer form a lamination including at least two layers.
